(19) United States
(12) Patent Application Publication
(10) Pub. No.: US 2012/0231142 A1
(43) Pub. Date: Sep. 13, 2012

(54) Omega-3 Fatty Acid Enriched Soups and Sauces

(75) Inventors: Candice Lucak, St. Louis, MO (US); Beata E. Lambach, St. Louis, MO (US); Jennifer White, St. Louis, MO (US); Jane Whittinghill, Florissant, MO (US); David Welsby, University City, MO (US)

(73) Assignee: SOLAE, LLC, St. Louis, MO (US)

(21) Appl. No.: 13/390,880

(22) PCT Filed: Jul. 15, 2010
(86) PCT No.: PCT/US10/42125

§ 371 Date: May 24, 2012

Related U.S. Application Data
(60) Provisional application No. 61/225,757, filed on Jul. 15, 2009.

(51) Int. Cl. A23L 1/30; A23L 2/39; A23L 1/305; A23D 9/00; A23L 1/40; A23L 3/3454

(52) U.S. Cl. 426/541; 426/589; 426/601; 426/590

(57) ABSTRACT

The present invention relates to compositions and methods for producing a soup or sauce composition with an amount of long chain fatty acids. Specifically, the soup or sauce composition comprises an amount of stearidonic acid (SDA) enriched soybean oil that imparts improved nutritional quality with an amount of long chain fatty acids, but retains the mouthfeel, flavor, odor, and other sensory characteristics associated with typical soup or sauce compositions.

This application claims priority from Provisional Application Ser. No. 61/225,757 filed on Jul. 15, 2009, which is hereby incorporated by reference in its entirety.

### FIELD OF THE INVENTION

The present invention generally relates to a food product composition with a quantity of polyunsaturated fatty acids and the method of making such a composition. More specifically, the invention is to a soup or sauce composition that comprises a quantity of stearidonic acid (SDA) enriched soybean oil and the method of making the composition. The soup or sauce composition possesses improved nutritional qualities through the use of the SDA enriched soybean oil to produce soup or sauce compositions with a quantity of omega-3 polyunsaturated fatty acids (n-3 PUFAs).

### BACKGROUND OF THE INVENTION

Recent dietary studies have suggested that certain types of fats are beneficial to body functions and improved health. The use of dietary fats is associated with a variety of therapeutic and preventative health benefits. Current research has demonstrated that the consumption of foods rich in n-3 PUFAs and especially omega-3 long chain polyunsaturated fatty acids (n-3 LC PUFAs), such as eicosapentaenoic acid (EPA; 20:5, n-3) and docosahexaenoic acid (DHA; 22:6, n-3) decreases cardiovascular death by positively impacting a number of markers, such as decreasing plasma triglycerides and blood pressure, and reducing platelet aggregation and inflammation. Typically, PUFAs, PUFAs, including n-3 LC PUFAs, are derived from plant or marine sources. Marine oils, found in fatty fish, are an important dietary source of the n-3 PUFAs, such as EPA and DHA. While fatty fish may be the best source of these omega-3 fatty acids, many individuals do not like the taste of such seafood, do not have ready access to such seafood, or cannot afford such seafood. One solution is to supplement the diet with cod liver oil or fish oil capsules, but many people find the consumption of large capsules (ca. 1 g each) difficult to consume, and so this solution has limited compliance. Another solution is to add n-3 PUFAs rich fish oils directly to foods, such as soups, sauces, and other food compositions.

A challenge with the latter approach is to provide the benefits of n-3 PUFAs without imparting any offending fish flavors or fish odors, which develop as a consequence of lipid oxidation. Currently, soups or sauces may be found in the marketplace that include a quantity of n-3 PUFAs derived from) flax, used either as full-fat flour or as oil, both providing a-linolenic acid (ALA; 18:3 n-3), marine-based sources, such as fish oil, or from land-based algal sources produced by fermentation, typically DHA in this case. These ingredients contribute a significant quantity of n-3 PUFAs, but these sources of n-3 PUFAs are typically unstable and are especially susceptible to rapid oxidation and produce unpleasant off flavors, typically described as painty or fishy. Consequently, in current products containing n-3 PUFAs from these sources, the levels of inclusion are very low and generally insufficient to have the desired health impact found at higher dietary levels of use. Because of the generally high temperature and other extreme processing conditions and subsequent reheating by a consumer the soup or sauces compositions must endure, the unstable n-3 PUFAs found in the marine or algal-derived sources produce highly undesirable fishy or painty off-flavors and odors when developing/retorting/processing/storing/reheating the soup or sauce compositions. Therefore, there is a need for soup or sauce compositions that include a physiologically significant quantity of n-3 PUFAs, that may be included with soup or sauce compositions that are then prepared and processed under normal conditions and does not produce fishy or other unacceptable flavors or odors in the final products.

Additionally, it is possible to consume certain plant derived food products or supplements that contain n-3 PUFAs. These plant derived n-3 PUFAs consist of α-linolenic acid (ALA; 18:3, n-3), ALA is susceptible to oxidation which results in painty off-odors. Moreover the bioconversion of ALA to n-3 PUFAs (specifically EPA) is relatively inefficient. Thus, there is a need for forms of n-3 PUFAs that provide the benefits of ready conversion to n-3 LC PUFAs, as well as good oxidative stability in foods. Additionally, there is a need for a process that includes a quantity of stable n-3 PUFAs that is readily metabolized to n-3 LC PUFAs and the resultant soups or sauces. As previously stated, the plant derived n-3 PUFAs (ALA) are also susceptible to oxidization and can impart offensive painty odors and tastes when exposed to extreme processing steps and the processing environment. Therefore, there is a need for a process and resultant soup or sauce compositions, that include a quantity of n-3 PUFAs, that are stable and do not impart fishy or painty odors or tastes due to oxidation of the n-3-PUFAs during the processing steps, while being transported, or stored before consumption.

### SUMMARY OF THE INVENTION

The present invention is a food composition such as soup or sauce compositions that includes a quantity of SDA enriched soybean oil. The food composition is broadly defined as a fluid, semi-fluid, or solid matrix food product. The SDA enriched soybean oil contains n-3 PUFAs that when incorporated into the soup or sauce compositions, provides a clean flavor, longer shelf-life stability, minimal oxidation, stability when exposed to extreme processing conditions, stability when exposed to reheating by a consumer and enhanced nutritional qualities when compared to other sources of n-3 PUFAs. Further, the soup or sauce compositions with the SDA enriched soybean oil possess similar taste, mouthfeel, odor, flavor, and sensory properties when compared to products made from conventional oils, such as soybean oil, but with increased nutritional values.

Additionally, the soup or sauce compositions may include at least one stabilizing agent such as a synthetic antioxidant, a natural antioxidant or lecithin. Other stabilizing agents, such as other phospholipids or other antioxidants can be combined with the SDA enriched soybean oil for incorporation into the soup or sauce compositions. The incorporation of the at least one stabilizing agent produces soup or sauce food compositions that possess similar taste, mouthfeel, odor, flavor, and sensory properties when compared to products made from conventional oils, such as soybean oil, but with increased nutritional values, and further has enhanced storage and shelf stability.

Further, the soup or sauce compositions may include a quantity of protein such as soy protein, pea protein, milk protein, rice protein, collagen, and combinations thereof. The soup or sauce compositions containing protein may include at least one stabilizing agent.

The present invention is also directed to a method of using SDA enriched soybean oil and at least one stabilizing agent to produce a soup or sauce composition that has enhanced nutritional qualities but similar taste, mouthfeel, odor, flavor, and sensory properties when compared to a typical soup or sauce composition.

The current invention demonstrates a process, composition, end product, and method of using SDA enriched oil for soup or sauce compositions that possess certain nutritional and beneficial qualities for a consumer and have enhanced storage and shelf stability. The soup or sauce compositions also have similar taste, mouthfeel, odor, and flavor as that found in typical soup or sauce compositions desired by consumers.

### DESCRIPTION OF THE FIGURES

FIG. 1 graphically illustrates the sensory profiling of condensed cream soup flavor, texture, and aftertaste differences based on soybean oil and SDA oil. The black dashed line marks the Recognition Threshold Level.

FIG. 2 summarizes consumer acceptance ratings for condensed cream soup prepared with soybean oil and SDA oil.

FIG. 3 graphically illustrates the sensory profiling of vegetable broth flavor and aftertaste differences based on soybean oil and SDA oil. The black dashed line marks the Recognition Threshold Level.

FIG. 4 summarizes consumer acceptance ratings for vegetable broth prepared with soybean oil and SDA oil.

FIG. 5 graphically illustrates the sensory profiling of basic cream sauce flavor, texture, and aftertaste differences based on soybean oil and SDA oil. The black dashed line marks the Recognition Threshold Level.

FIG. 6 graphically illustrates the sensory profiling of tomato based pasta sauce flavor, texture, and aftertaste differences based on soybean oil and SDA oil. The black dashed line marks the Recognition Threshold Level.

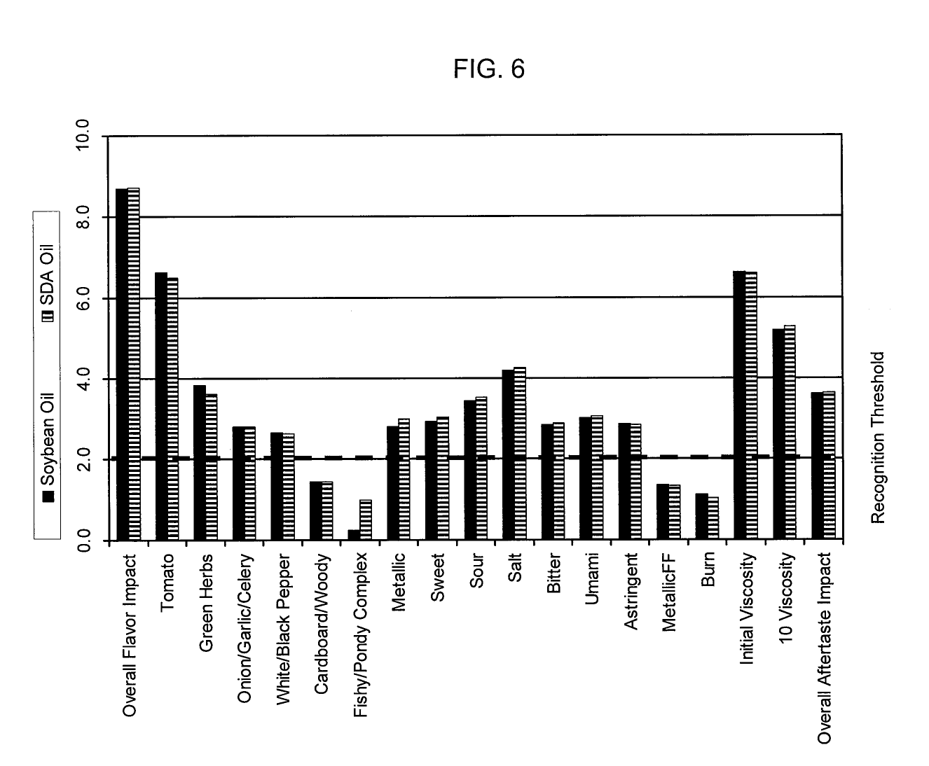

FIG. 7 summarizes consumer acceptance ratings for tomato based pasta sauce prepared with soybean oil and SDA oil.

FIG. 8 graphically illustrates the sensory profiling of dry blended soup flavor and aftertaste differences based on soybean oil fat powder and SDA oil fat powder. The black dashed line marks the Recognition Threshold Level.

FIG. 9 summarizes consumer acceptance ratings for dry blended soup prepared with soybean oil fat powder and SDA oil fat powder.

### DETAILED DESCRIPTION OF THE INVENTION

The present invention relates to a method of using SDA enriched soybean oil, a process for producing soup or sauce compositions, and the resultant soup or sauce compositions that have an increased nutritional value for consumption by a consumer to improve their health. Further, the invention is to soup or sauce compositions with increased nutritional values that include a quantity of n-3 PUFAs but retain the mouthfeel, flavor, odor, and other sensory characteristics of typical soup or sauce food compositions that consumers desire.

Use of PUFAs and especially n-3 PUFAs in soup or sauce compositions is typically limited by their lack of oxidative stability. The processing conditions that soup or sauce compositions must undergo, and the extreme reheating by a consumer before consumption cause n-3 PUFAs to readily oxidize and produce off flavors in the finished soup or sauce compositions. By using a type of n-3 PUFAs that is oxidatively stable during mixing, processing, and packaging phases and during storage, transport, shelf life, and cooking (reheating) by the consumer soup or sauce compositions are produced that not only retain the mouthfeel, flavor, odor, and other characteristics typical soup or sauce compositions posses but also have increased nutritional value.

### (I) Compositions

One aspect of the present invention is sauce or soup compositions that comprise a quantity of n-3 PUFAs. The n-3 PUFAs are incorporated into the sauce or soup compositions through the use of SDA enriched soybean oil. In one embodiment, the SDA enriched soybean oil is obtained from soybeans that are engineered to produce high levels of SDA, such as those described in WO2008/085840 and WO2008/085841. The soybeans can be processed according to the extraction method consistent with those methods described in US Patent Application 2006/0111578 and 2006/0111254. In another embodiment, oil obtained from other plant sources with elevated SDA, such as but not limited to Echium spp and blackcurrant oil can be used.

In another embodiment soy flour can be used that is enriched with SDA, either from SDA enriched soybeans or through other processes known in the industry. The SDA enriched soy flour is produced according to typical processes known in the industry, with the SDA enriched soy flour used to replace current soy flour or other flours and ingredients during the production of the soup or sauce compositions. The resultant product is a soup or sauce composition with the desired nutritional characteristics that retains the mouthfeel, flavor, odor, and other sensory characteristics of typical soup or sauce compositions.

In another embodiment, the soup or sauce composition may further include at least one stabilizing agent, such as an antioxidant. Antioxidants include but are not limited to synthetic antioxidants, natural antioxidants, phospholipids and combinations thereof. Antioxidants stabilize the oxidizable material and thus reduce its oxidation. The concentration of the at least one stabilizing agent will generally range from less than 0.01% to about 65% by weight of the SDA enriched soybean oil. The at least one stabilizing agent can be added at a variety of places during the process of making the compositions. The at least one stabilizing agent may be added directly to the SDA enriched soybean oil. The at least one stabilizing agent may be added to the composition to which the SDA enriched soybean oil is added. Finally, the at least one stabilizing agent could be added both directly to the SDA enriched soybean oil and the composition containing the SDA enriched soybean oil. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Common antioxidants include tocopherols, ascorbyl palmitate, ascorbic acid, and rosemary extract. Phospholipids include but are not limited to lecithin. A phospholipid comprises a backbone, a negatively charged phosphate group attached to an alcohol, and at least one fatty acid. Phospholipids having a glycerol backbone comprise two fatty acids and are termed glycerophospholipids. Examples of a glycerophospholipid include phosphatidylcholine, phosphatidylethanolamine, phosphatidylinositol, phosphatidylserine, and diphosphatidylglycerol (i.e., cardiolipin). Phospholipids having a sphingosine backbone are called sphingomyelins. The fatty acids attached via ester bonds to the backbone of a phospholipid tend to be 12 to 22 carbons in length, and some may be unsaturated. For example, phospholipids may contain oleic acid (18:1), linoleic acid (18:2, an n-6), and alpha-linolenic acid (18:3, an n-3). The two fatty acids of a phospholipid may be the same or they may be different; e.g., dipalmitoylphosphatidylcholine, 1-stearyoyl-2-myristoylphosphatidylcholine, or 1-palmitoyl-2-linoleoylethanolamine.

In one embodiment, the phospholipid may be a single purified phospholipid, such as distearoylphosphatidylcholine. In another embodiment, the phospholipid may be a mixture of purified phospholipids, such as a mix of phosphatidylcholines. In still another embodiment, the phospholipid may be a mixture of different types of purified phospholipids, such as a mix of phosphatidylcholines and phosphatidylinositols or a mixture of phosphatidylcholines and phosphatidylethanolamines.

In an alternative embodiment, the phospholipid may be a complex mix of phospholipids, such as a lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin may be de-oiled and treated such that it is an essentially pure mixture of phospholipids. Lecithin may be modified to make the phospholipids more water-soluble. Modifications include hydroxylation, acetylation, and enzyme treatment, in which one of the fatty acids is removed by a phospholipase enzyme and replaced with a hydroxyl group. In another embodiment the lecithin could be produced as a byproduct of the oil production from the SDA enriched soybeans, thus producing a product with a portion of the lecithin to be used with the SDA enriched soybean oil.

In yet another alternative embodiment, the phospholipid may be a soy lecithin produced under the trade name SOLEC® by Solae LLC (St. Louis, Mo.). The soy lecithin may be SOLEC®F, a dry, de-oiled, non-enzyme modified preparation containing about 97% phospholipids. The soy lecithin may be SOLEC®8160, a dry, de-oiled, enzyme-modified preparation containing about 97% phospholipids. The soy lecithin may be SOLEC® 8120, a dry, de-oiled, hydroxylated preparation containing about 97% phospholipids. The soy lecithin may be SOLEC®8140, a dry, de-oiled, heat resistant preparation containing about 97% phospholipids. The soy lecithin may be SOLEC®R, a dry, de-oiled preparation in granular form containing about 97% phospholipids.

The ratio of the at least one antioxidant to the SDA enriched soybean oil will vary depending upon the nature of the SDA enriched soybean oil and the antioxidant preparation. In particular, the concentration of antioxidant will be of a sufficient amount to prevent the oxidation of the SDA enriched soybean oil. The concentration of the antioxidant will generally range from less than 0.01% to about 65% by weight of the SDA enriched soybean oil. In one embodiment, the concentration of the antioxidant may range from about 2% to about 50% by weight of the SDA enriched soybean oil. In another embodiment, the concentration of the antioxidant may range from about 2% to about 10% by weight of the SDA enriched soybean oil. In an alternative embodiment, the concentration of the antioxidant may range from about 10% to about 20% by weight of the SDA enriched soybean oil. In yet another embodiment, the concentration of the antioxidant may range from about 20% to about 30% by weight of the oxidizable material. In still another embodiment, the concentration of the antioxidant may range from about 30% to about 40% by weight of the SDA enriched soybean oil. In another alternate embodiment, the concentration of the antioxidant may range from about 40% to about 50% by weight of the SDA enriched soybean oil. In another embodiment, the concentration of the antioxidant may range from about 15% to about 35% by weight of the SDA enriched soybean oil. In another embodiment, concentration of the antioxidant may range from about 25% to about 30% by weight of the SDA enriched soybean oil.

The soup or sauce compositions may include a quantity of a protein such as soy protein, pea protein, milk protein, rice protein, collagen, and combinations thereof. The soup or sauce compositions containing protein may also include at least one stabilizing agent.

### (II) Method of Using and Processes for Forming the Compositions

Production of the n-3 PUFAs enriched soup or sauce compositions is accomplished by replacing an amount of the typical soybean oil used as an ingredient with SDA enriched soybean oil for the soup or sauce compositions. In another embodiment, SDA enriched soybean oil can either replace part of or all of the existing fat or oil in an application or can be added additionally to those products that are naturally, or formulated to be low in fat. In one embodiment, the SDA enriched soybean oil will replace all the fat or oil used to produce the desired soup or sauce food product. In, an alternative embodiment, the SDA enriched soybean oil will replace an amount of the fat or oil used in the soup or sauce compositions to produce an end product that contains a sufficient amount of n-3 PUFAs as recommended by the industry. The general consensus in the omega-3 research community is for a consumer to consume around 400-500 mg/day of EPA/DHA equivalent. (Harris et al. (2009) J. Nutr. 139:804 S-819S). Typically a consumer will consume four (4) 100 mg/serving per day to ultimately consume 400 mg/day.

The soup or sauce compositions are generally formed dependent on the desired end product. The soup or sauce compositions are produced according to standard industry recipes except the fat or oil ingredient typically used is partially or totally replaced with the SDA enriched soybean oil. In another embodiment soup or sauce compositions are produced according to standard industry recipes and practices except an additional amount of the SDA enriched soybean oil is added to the recipe. The amount of SDA enriched soybean oil used will vary from 1% to 100% of the total fat and is dependent on the end product and the nutritional value or amount of n-3 PUFAs desired in the end product. In one embodiment 5% of the fat or oil used in a typical soup or sauce food composition is replaced with the SDA enriched soybean oil. In another embodiment 10% of the fat or oil used in a typical soup or sauce food composition product is replaced with the SDA enriched soybean oil. In another embodiment 25% of the fat or oil used in a typical soup or sauce food composition is replaced with the SDA enriched soybean oil. In another embodiment 50% of the fat or oil used in a typical soup or sauce food composition is replaced with the SDA enriched soybean oil. In another embodiment 75% of the fat or oil used in a typical soup or sauce food composition is replaced with the SDA enriched soybean oil. In another embodiment 90% of the fat or oil used in a typical soup or sauce food composition is replaced with the SDA enriched soybean oil. In another embodiment 95% of the fat or oil used in a typical soup or sauce food composition is replaced with the SDA enriched soybean oil. In another embodiment 100% of the fat or oil used in a typical soup or sauce food composition is replaced with the SDA enriched soybean oil.

In another embodiment a quantity of at least one stabilizing agent, such as an antioxidant, is added to the soup or sauce food composition. In one embodiment, the antioxidant is a lecithin and is combined with the SDA enriched soybean oil, the concentration of the lecithin in the soup or sauce food composition is from less than 0.01% to about 65% by weight of the SDA enriched soybean oil, and more typically, from about 15% to about 35% by weight of the SDA enriched soybean oil. In another embodiment, the concentration of the lecithin in the soup or sauce food composition is from about 25% to about 30% by weight of the SDA enriched soybean oil. In another embodiment an amount of SDA enriched soybean oil can be added in addition to the fat or oil typically used in the soup or sauce.

In a further embodiment, a quantity of protein is added to the soup or sauce composition. The protein can be any protein known to work in soups or sauces including but not limited to soy protein, pea protein, milk protein, rice protein, collagen, and combinations thereof. Soy protein that can be incorporated in the soup or sauces composition include soy protein isolate, soy protein concentrate, soy flour, and combinations thereof.

After including an amount of the SDA enriched soybean oil and the phospholipid the soup or sauce food mixture is then processed according to typical industry recipes. To produce the soup or sauce food compositions, no additional processing or ingredients other than those typically used to produce the desired soup or sauce compositions are required, although at least one stabilizing agent may be included.

### (III) Food Products

A further aspect of the present invention are soup or sauce compositions with n-3 PUFAs incorporated and increased nutritional values, but retains the mouthfeel, flavor, odor, and other sensory characteristics of typical soup or sauce compositions. The soup or sauce compositions will vary depending on the desired end product but can include liquid food composition broadly defined as a fluid, semi-fluid, or solid matrix food product, including but not limited to soups, sauces, and gravy. Additional examples include, but are not limited to the following: ready-to serve or ready-to-eat soups, canned condensed soups, dry mix soups, clear soups, thick soups, broths, cream soups, bisques, chowders, purees, meat based soups, vegetable based soups, meat and vegetable soups, soups with particulates, cold or chilled soups, dessert soups, fish soups, beverage soups, fermented soups, and combinations thereof. Examples of sauces include, without limitation, ready made sauces, salad sauces, pan sauces, vegetable sauces, dessert sauces, chocolate sauces, caramel sauces, white sauces, brown sauces, emulsified sauces, sweet sauces, fruit sauces, jellies, jams, preserves, chutney, compotes, apple sauce, puddings, gelatin, mole sauces, sauce bases, such as espangole, veloutè, Béchamel, Hollandaise, salsas, relishes, gravies and cooked sauces. Non-limiting examples of gravies include, without limitation, various types of pan gravies, thickened style gravies and ready-to-serve gravies.

Fat Powders

In one embodiment, an amount of n-3 PUFAs may be included in a fat powder composition to produce an n-3 PUFAs enriched fat powder. Fat powders, or powdered fats, comprise a range of fat compositions, from highly saturated to highly unsaturated, and a range of fat levels. The range is dependent on the desired end product and is typically from about 35% to about 90% fat. In one embodiment the fat powders contain an amount of any functional protein with good emulsification properties currently used in the industry, one example is sodium caseinate. In another embodiment highly functional soy protein isolates (for example SUPRO®120 from Solae, St. Louis, Mo.) can be used, at about 2% to about 5% by weight, with the remainder of the non-fat solids made up from maltodextrin. In an additional embodiment monoglyceride, or mono- and diglyceride emulsifiers, or other lipophilic emulsifiers, may be used.

Production of the n-3 PUFAs enriched fat powder are accomplished by replacing an amount of the typical soybean oil used as an ingredient with SDA enriched soybean oil for the fat powder compositions. In another embodiment, SDA enriched soybean oil can either replace part of or all of the existing fat in an application or can be added additionally to those products that are naturally, or formulated to be low in fat. In one embodiment, the SDA enriched soybean oil will replace all the soybean oil used to produce the desired fat powder. In an alternative embodiment, the SDA enriched soybean oil will replace an amount of the soybean oil, or fat powder, used in the recipes to produce an end product that contains a sufficient amount of n-3 PUFAs as recommended by the industry. The general consensus in the omega-3 research community is for a consumer to consume around 400-500 mg/day of EPA/DHA equivalent. (Harris et al. (2009) J. Nutr. 139:804 S-819S). Typically a consumer would consume four (4) 100 mg/serving per day to ultimately consume 400 mg/day.

The fat powder compositions are generally formed dependent on the desired end product. The fat powder compositions are produced according to standard industry recipes except the oil ingredient typically used is partially or totally replaced with the SDA enriched soybean oil. In another embodiment fat powder compositions are produced according to standard industry recipes and practices except an additional amount of the SDA enriched soybean oil is added to the recipe. The amount of SDA enriched soybean oil used will vary from 1% to 100% and is dependent on the end product and the nutritional value or amount of omega-3 desired in the end product. In one embodiment 5% of the fat or oil used in a typical fat powder composition is replaced with the SDA enriched soybean oil. In another embodiment 10% of the fat or oil used in a typical fat powder composition product is replaced with the SDA enriched soybean oil. In another embodiment 25% of the fat or oil used in a typical fat powder composition is replaced with the SDA enriched soybean oil. In another embodiment 50% of the fat or oil used in a typical fat powder composition is replaced with the SDA enriched soybean oil. In another embodiment 75% of the fat or oil used in a typical fat powder composition is replaced with the SDA enriched soybean oil. In another embodiment 90% of the fat or oil used in a typical fat powder composition is replaced with the SDA enriched soybean oil. In another embodiment 95% of the fat or oil used in a typical fat powder composition is replaced with the SDA enriched soybean oil. In another embodiment 100% of the fat or oil used in a typical fat powder composition is replaced with the SDA enriched soybean oil.

The process for producing the n-3 PUFAs enriched fat powder composition begins by heating the fat to a temperature several degrees above its slip/melting point and to add any fat soluble emulsifiers demanded by the formulation and allow them to dissolve. Lecithin or other phospholipids, and other antioxidants, such as those typically used in fat blends and outlined above may be included at this stage. In a separate mixing vessel, deionized water is added in a quantity sufficient to dissolve the proteins and the carbohydrate. In the case of isolated soy protein, chelating agents, such as sodium citrate or sodium phosphates may be added to the water prior to the protein addition. The soy protein is dispersed in the water and the slurry is heated to 75° C.-80° C. and held for 30 minutes, or, more optimally, homogenized at 200 bar before the maltodextrin is added. The aqueous phase is then combined with the fat phase and thoroughly mixed. At this point, the process depends on the final fat content target. If a low fat content is desired (about between 40%-60%), the mixture can be homogenized in a piston-type homogenizer at around 100 bar to obtain a good emulsion. This emulsion can be pumped to a spray drier and dried, using centrifugal or nozzle atomization. Typical inlet temperatures might be 180° C., with outlet temperatures of 80° C.-90° C. If a high fat content is desired (60%-90%), high-pressure homogenization can invert the emulsion, producing a water in oil emulsion (effectively, a margarine) that cannot be dried. In these cases, it is much more effective to use a high pressure piston pump to transfer the pre-emulsion to a spray nozzle in a drier, and form the emulsion at the exit to the nozzle inside the drier. Drying is accomplished in a manner similar to the lower fat powders, with the dried product separated from the outlet air using filter bags, or, more commonly, cyclones. For either low or high fat concentrations, the powders are rapidly cooled by transporting them on a metal belt conveyer that is cooled from the underside with chilled water so as to achieve the rapid fat crystallization and a non-caking final product.

In another embodiment, the fat powder composition may further include at least one stabilizing agent, such as an antioxidant. Antioxidants include but are not limited to synthetic antioxidants, natural antioxidants, phospholipids and combinations thereof. Antioxidants stabilize the oxidizable material and thus reduce its oxidation. The concentration of the at least one antioxidant will generally range from less than 0.01% to about 65% by weight of the SDA enriched soybean oil. The at least one stabilizing agent can be added at a variety of places during the process of making the fat powder compositions. The at least one stabilizing agent may be added directly to the SDA enriched soybean oil. The at least one stabilizing agent may be added to the fat powder composition to which the SDA enriched soybean oil is added. Finally, the at least one stabilizing agent could be added both directly to the SDA enriched soybean oil and the fat powder composition containing the SDA enriched soybean oil. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Common antioxidants include tocopherols, ascorbyl palmitate, ascorbic acid, and rosemary extract. Phospholipids include but are not limited to lecithin. A phospholipid comprises a backbone, a negatively charged phosphate group attached to an alcohol, and at least one fatty acid. Phospholipids having a glycerol backbone comprise two fatty acids and are termed glycerophospholipids. Examples of a glycerophospholipid include phosphatidylcholine, phosphatidylethanolamine, phosphatidylinositol, phosphatidylserine, and diphosphatidylglycerol (i.e., cardiolipin). Phospholipids having a sphingosine backbone are called sphingomyelins. The fatty acids attached via ester bonds to the backbone of a phospholipid tend to be 12 to 22 carbons in length, and some may be unsaturated. For example, phospholipids may contain oleic acid (18:1), linoleic acid (18:2, an n-6), and alpha-linolenic acid (18:3, an n-3). The two fatty acids of a phospholipid may be the same or they may be different; e.g., dipalmitoylphosphatidylcholine, 1-stearyoyl-2-myristoylphosphatidylcholine, or 1-palmitoyl-2-linoleoylethanolamine.

In one embodiment, the phospholipid may be a single purified phospholipid, such as distearoylphosphatidylcholine. In another embodiment, the phospholipid may be a mixture of purified phospholipids, such as a mix of phosphatidylcholines. In still another embodiment, the phospholipid may be a mixture of different types of purified phospholipids, such as a mix of phosphatidylcholines and phosphatidylinositols or a mixture of phosphatidylcholines and phosphatidylethanolamines.

In an alternative embodiment, the phospholipid may be a complex mix of phospholipids, such as a lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin may be de-oiled and treated such that it is an essentially pure mixture of phospholipids. Lecithin may be modified to make the phospholipids more water-soluble. Modifications include hydroxylation, acetylation, and enzyme treatment, in which one of the fatty acids is removed by a phospholipase enzyme and replaced with a hydroxyl group. In another embodiment the lecithin could be produced as a byproduct of the oil production from the SDA enriched soybeans, thus producing a product with a portion of the lecithin to be used with the SDA enriched soybean oil.

In yet another alternative embodiment, the phospholipid may be a soy lecithin produced under the trade name SOLEC® by Solae LLC (St. Louis, Mo.). The soy lecithin may be SOLEC®F, a dry, de-oiled, non-enzyme modified preparation containing about 97% phospholipids. The soy lecithin may be SOLEC®8160, a dry, de-oiled, enzyme-modified preparation containing about 97% phospholipids. The soy lecithin may be SOLEC® 8120, a dry, de-oiled, hydroxylated preparation containing about 97% phospholipids. The soy lecithin may be SOLEC®8140, a dry, de-oiled, heat resistant preparation containing about 97% phospholipids. The soy lecithin may be SOLEC®R, a dry, de-oiled preparation in granular form containing about 97% phospholipids.

The ratio of the at least one antioxidant to the SDA enriched soybean oil will vary depending upon the nature of the SDA enriched soybean oil and the antioxidant preparation. In particular, the concentration of antioxidant will be of a sufficient amount to prevent the oxidation of the SDA enriched soybean oil. The concentration of the at least one stabilizing agent will generally range from less than 0.01% to about 65% by weight of the SDA enriched soybean oil. In one embodiment, the concentration of the at least one stabilizing agent may range from about 2% to about 50% by weight of the SDA enriched soybean oil. In another embodiment, the concentration of the at least one stabilizing agent may range from about 2% to about 10% by weight of the SDA enriched soybean oil. In an alternative embodiment, the concentration of the at least one stabilizing agent may range from about 10% to about 20% by weight of the SDA enriched soybean oil. In yet another embodiment, the concentration of the at least one stabilizing agent may range from about 20% to about 30% by weight of the oxidizable material. In still another embodiment, the concentration of the at least one stabilizing agent may range from about 30% to about 40% by weight of the SDA enriched soybean oil. In another alternate embodiment, the concentration of the at least one stabilizing agent may range from about 40% to about 50% by weight of the SDA enriched soybean oil. In another embodiment, the concentration of the at least one stabilizing agent may range from about 15% to about 35% by weight of the SDA enriched soybean oil. In another embodiment, concentration of the at least one stabilizing agent may range from about 25% to about 30% by weight of the SDA enriched soybean oil.

The fat powder compositions may include a quantity of a protein such as soy protein, pea protein, milk protein, rice protein, collagen, and combinations thereof. The fat powder compositions containing protein may also include at least one stabilizing agent.

The n-3 PUFAs enriched fat powder composition can be used as any current fat powder composition in the industry including use in a dry blend with other components of dried soup mixtures, such as modified or native starches, dried meats, fish and seafood, vegetables, herbs and spices and other seasonings, etc., depending on the flavor variety. The n-3 PUFA enriched fat powder compositions replace the use of current fat powder compositions on the market and used in the industry and creates final products with the same flavor and sensory characteristics as typical fat powder compositions but with enhanced nutritional values a previously described. The n-3 PUFAs enriched fat powder compositions can also be used in other dry powder foods that require the addition of fat in powder form. Such powdered food products include, but are not limited to, dry blended beverages for weight loss or weight gain, dry blended beverages for sports nutritional purposes, infant formulas, clinical nutrition products, dry blended soups and combinations thereof.

### DEFINITIONS

To facilitate understanding of the invention several terms are defined below.

The term “n-3 PUFAs” refers to omega-3 polyunsaturated fatty acids and includes omega-3 long chain polyunsaturated fatty acids and n-3 LCPUFAs.

The terms “stearidonic acid enriched soybean oil”, “SDA enriched soybean oil”, and “SDA oil” refer to soybean oil that has been enriched with stearidonic acid.

The term “milk” refers to animal milk, plant milk, and nut milk. Animal milk is a white fluid secreted by the mammary glands of female mammals consisting of minute globules of fat suspended in a solution of casein, albumin, milk sugar, and inorganic salts. Animal milk includes but is not limited to milk from cows, goats, sheep, donkeys, camels, camelids, yaks, water buffalos. Plant milk is a juice or sap found in certain plants and includes but is not limited to milk derived from soy, and other vegetables. Nut milk is an emulsion made by bruising seeds and mixing with a liquid, typically water. Nuts that can be used for milk include but are not limited to almonds and cashews.

The term “milk protein” refers to any protein contained in milk as defined above, including any fractions extracted from the milk by any means known in the art. Milk protein further includes any combinations of milk proteins.

The following examples are used herein to illustrate different aspects of this invention and are not meant to limit the present invention in any way. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

### EXAMPLES

### Example 1

### Preparation of the Condensed Cream Soup Formulation

In the present disclosure, a condensed cream soup was prepared by combining a cream portion with a thickener portion to produce a condensed cream soup, as indicated in Table 1.

For the condensed cream soup a cream portion was created by adding 1738 g of water to a Waring® blender (Model 38BL52, Waring Products, Torrington, Conn.) along with 71.8 g soy protein isolate. The soy protein isolate was dispersed slowly at ambient temperature and low blender speed for 1 minute. The cream portion was then transferred to a medium stainless steel steam jacketed kettle (Model TDA-10, Groen Corp., Elk Grove Village, Ill.) and heated to 82° C. (180° F.) with a 5 minute holding time at this temperature. 188.2 g sweet dairy whey powder was dispersed into the slurry and mixed until a homogeneous slurry mixture was produced.

In a small stainless steel steam jacketed kettle (Model TDA-6), 206 g of Dairy Whipping Cream (40% milk fat) and 940 g of soybean oil were preheated at 66° C. (150° F.) and added to the cream portion together with the 2856 g of water to form an emulsion. The emulsion was heated to 66° C.-68° C. (150° F.-155° F.) for 2 minutes.

A Gaulin APV-15MR-8TBA homogenizer (Manton Gaulin Manufacturing Company, Inc., Everett, Mass.) was preheated by running water at a temperature greater than 71° C. (160° F.) through it. The emulsion mixture was homogenized at 66° C. (150° F.) using a two stage process, at 2500 psi (180 bar) for the first stage, and at 500 psi (35 bar) for the second stage. The first liter of the emulsion leaving the homogenizer was discarded and appropriate amounts of the emulsion were collected and weighed for each soup batch formulation.

In another small stainless steel steam jacketed kettle, Model TDA-6 (Groen Corp.) a thickener mixture was created by adding 742 g thickener dispersion water, 120 g corn starch, 70 g modified starch, and 120 g wheat flour were mixed until smooth and heated to 85° C.-90° C. (185° F.-195° F.).

In a large stainless steel steam jacketed kettle, Model TDA-20 (Groen, Corp.), 3189.3 g of soup kettle water, 3000 g of the emulsion, 2500 g of the thickener mixture, 165 g salt, 40 g monosodium glutamate, 2.5 g yeast extract, 3 g white pepper and 0.2 g garlic powder were combined and heated to 85° C.-90° C. (185° F.-195° F.).

The batch was divided into two portions by removing 1780 g of soup and adding 220 g of water. One portion was heated up to 90° C. (195° F.) and immediately canned into 10 ounce Soup Cans (4 inch×2 11/16 inch w/white lining) (Ball Corp., Broomfield, Colo.) with ⅛ inch headspace. The canned condensed cream soup was sealed and stored in an ice bath and then refrigerated overnight.

To the remaining portion, 880 g chopped fresh mushrooms was added and heated to 90° C. (195° F.), with a 1 minute hold while mixing and immediately canned into 10 ounce Soup Cans (4 inch×2 11/16 inch w/white lining) (Ball Corp) with ⅛ inch headspace. The canned condensed mushroom cream soup was sealed and stored in an ice bath and then refrigerated overnight.

The same steps as above were repeated except, instead of using 940 g soybean oil to create the emulsion, a combination of 624 g soybean oil and 316 g SDA soybean oil were used.

The following day the soup cans were retorted in a static Pilot Plant retort, (maximum pressure 75 psi (5 bar) at maximum 149° C. (300° F.) from JBT Food Tech Madera (Madera, Calif.) with Calsoft Data Gathering) at 121° C. (250° F.) for 65 minutes at a pressure of 15 psi (1 bar). After retorting, cans were cooled in ice water for 15 minutes. The sterilized canned product was then stored in the refrigerator until further use.

TABLE 1
Batch Formulation for condensed cream soup

| | Formulation for Condensed Cream Soup | | | |
|---|---|---|---|---|
| | Soybean | Soybean | SDA | SDA |
| | Oil | Oil | Oil | Oil |
| | % | g | % | g |
| Cream Portion | | | | |
| Water (hydration) | 8.690 | 1738.00 | 8.690 | 1738.00 |
| Soy Protein Isolate | 0.359 | 71.80 | 0.359 | 71.80 |
| Sweet Dairy Whey Powder | 0.941 | 188.20 | 0.941 | 188.20 |
| Soybean Oil | 4.700 | 940.00 | 3.263 | 652.60 |
| SDA Oil | 0.000 | 0.00 | 1.420 | 287.35 |
| Stabilizing Agent | 0.000 | 0.00 | 0.017 | 0.05 |
| Dairy Whipping Cream | 1.030 | 206.00 | 1.030 | 206.00 |
| Water (Emulsion Tank) | 14.280 | 2856.00 | 14.280 | 2856.00 |
| Total Cream Portion | 30.000 | 6000.00 | 30.000 | 6000.00 |
| Thickener Portion | | | | |
| Wheat Flour | 5.680 | 568.00 | 5.680 | 568.00 |
| Corn Starch | 1.200 | 120.00 | 1.200 | 120.00 |
| Modified Food Starch | 0.700 | 70.00 | 0.700 | 70.00 |
| Water (for thickeners) | 17.420 | 1742.00 | 17.420 | 1742.00 |
| Total Thickener Portion | 25.000 | 2500.00 | 25.000 | 2500.00 |
| Finished Soup | | | | |
| Emulsion | 30.00 | 3000.00 | 30.00 | 3000.00 |
| Thickener | 25.00 | 2500.00 | 25.00 | 2500.00 |
| Mushrooms | 11.00 | 1100.00 | 11.00 | 1100.00 |
| Salt | 1.650 | 165.00 | 1.650 | 165.00 |
| MSG | 0.400 | 40.00 | 0.400 | 40.00 |
| Yeast Extract | 0.025 | 2.50 | 0.025 | 2.50 |
| White Pepper | 0.030 | 3.00 | 0.030 | 3.00 |
| Garlic Powder | 0.002 | 0.20 | 0.002 | 0.20 |
| Water (Soup Kettle) | 31.893 | 3189.30 | 31.893 | 3189.30 |
| Total | 100.000 | 10000.00 | 00.000 | 10000.00 |

The result was a condensed cream soup that had an increased quantity of n-3 PUFAs, but retained the taste, structure, aroma, and mouthfeel of cream soup products currently on the market.

### Example 2

### Profiling of Condensed Cream Soup

Sensory descriptive analysis was conducted on condensed cream soup to understand the attribute differences of soybean oil and SDA oil in condensed cream soup. Seven panelists trained in the Sensory Spectrum™ Descriptive Profiling method evaluated the samples for 19 flavor attributes, 8 texture attributes, and 3 aftertaste attributes. The attributes were evaluated on a 15-point scale, with 0=none/not applicable and 15=very strong/high in each sample. Definitions of the flavor attributes are given in Table 2 and definitions of the texture attributes are given in Table 3.

In a saucepan, the samples were diluted by combining 1 can of condensed cream soup with 1 can of water, using the same can as the condensed cream soup was in. The saucepan was placed on the stove in which the samples were whisked until smooth then stirred as needed on medium to low heat until the condensed cream soup was heated to 71° C. (160° F.), which took approximately 12 minutes. Each panelist received 4 ounces of condensed cream soup in 5 ounce bowls. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 2
Flavor Attribute Lexicon

| Attribute | Definition | Reference | |
|---|---|---|---|
| | | Intensities based on | |
| | | Universal Scale: | |
| | | Baking Soda in | 2.5 |
| | | Saltine | |
| | | Cooked Apple in | 5.0 |
| | | Applesauce | |
| | | Orange in | 7.5 |
| | | Orange Juice | |
| | | Concord Grape in | 10.0 |
| | | Grape Juice | |
| | | Cinnamon in | 12.0 |
| | | Big Red Gum | |
| AROMATICS | | | |
| Overall Flavor | The overall intensity of the product aromas, | | |
| Impact | an amalgamation of all perceived aromatics, | | |
| | basic tastes and chemical feeling factors. | | |
| Mushroom | The aromatic associated with earthy/dirty, | Canned Mushroom Pieces | |
| | musty, woody characteristic of a mushroom. | | |
| Earthy/dirty | Aromatic characteristic of dry mud, dirt, or | Damp potting soil, dirt | |
| | soil, and damp soil wet foliage, or slightly | | |
| | undercooked boiled potato. | | |
| Musty | Aromatic associated with closed air spaces | Damp cloth stored in plastic bag, old | |
| | such as attics and closets (dry) and | books, white pepper | |
| | basements (wet). | | |
| Onion/Celery/Garlic | The aromatics associated with dehydrated | Onion, garlic and celery powder | |
| | onion, garlic and celery powders | solutions. Garlic Oil Capsules | |
| Grain | The aromatics associated with the total grain | All-purpose flour paste, cream of | |
| | impact, which may include all types of grain | wheat, whole wheat pasta | |
| | and different stages of heating. May include | | |
| | wheat, whole wheat, oat, rice, graham, etc | | |
| Metallic | The aromatic associated with metals, tin or | Iron tablet, canned tomato juice, | |
| | iron. | pennies | |
| Cardboard/Woody | The aromatics associated with dried wood | Toothpicks, Water from cardboard | |
| | and the aromatics associated with slightly | soaked for 1 hour | |
| | oxidized fats and oils, reminiscent of a | | |
| | cardboard box. | | |
| Milky | The slightly sour, animal, milky aromatic | Skim Milk | |
| | associated with skim milk and milk derived | | |
| | products. | | |
| Fishy/Pondy | The aroma/aromatics associated with | | |
| Complex | triethylamine, pond water or aged fish. The | | |
| | general term used to describe fish meat, | | |
| | which cannot be tied to a specific fish by | | |
| | name. | | |
| Fishy | Aromatic associated with trimethylamine and | Cod liver oil capsules, | |
| | old fish. | trimethylamine, Geisha canned lump | |
| | | crab, oxidized tea bag, dried parsley, | |
| | | tuna in pouch | |
| Pondy | The aromas and aromatics associated with | Algal oil (Martek 30% DHA oil) | |
| | water containing algae, reminiscent of pond | | |
| | water and aquatic tanks. | | |
| BASIC TASTES | | | |
| Sweet | The taste on the tongue stimulated by | Sucrose solution: | |
| | sucrose and other sugars, such as | 2% | 2.0 |
| | fructose, glucose, etc., and by other | 5% | 5.0 |
| | sweet substances, such as saccharin, | 10% | 10.0 |
| | Aspartame, and Acesulfam-K. | 16% | 15.0 |
| Sour | The taste on the tongue stimulated by | Citric acid solution: | |
| | acid, such as citric, malic, phosphoric, | 0.05% | 2.0 |
| | etc. | 0.08% | 5.0 |
| | | 0.15% | 10.0 |
| | | 0.20% | 15.0 |
| Salt | The taste on the tongue associated with | Sodium chloride solution: | |
| | sodium salts. | 0.2% | 2.0 |
| | | 0.35% | 5.0 |
| | | 0.5% | 8.5 |
| | | 0.57% | 10.0 |
| | | 0.7% | 16.0 |
| Bitter | The taste on the tongue associated with | Caffeine solution: | |
| | caffeine and other bitter substances, such | 0.05% | 2.0 |
| | as quinine and hop bitters. | 0.08% | 5.0 |
| | | 0.15% | 10.0 |
| | | 0.20% | 15.0 |
| Umami | The taste on the tongue associated with | MSG solution | |
| | monosodium glutamate. Savory. | 6% | 5.0: |
| CHEMICAL FEELING | | | |
| FACTOR | | | |
| Astringent | The shrinking or puckering of the tongue | Alum solution: | |
| | surface caused by substances such as | 0.05% | 3.0 |
| | tannins or alum. | 0.10% | 6.0 |
| | | 0.2% | 9.0 |

| | | |
|---|---|---|
| Burn | A chemical feeling factor associated | Lemon juice, vinegar |
| | with high concentration of irritants to the | |
| | mucous membranes of the oral cavity. | |

TABLE 3
Texture Attribute Lexicon

| Attribute | Definition | Reference Scale | |
|---|---|---|---|
| INITIAL | | | |
| Initial Viscosity | The rate of flow per unit force | Water | 1.0 |
| | across tongue. | Plain Silk | 2.0 |
| | Not viscous/Fast---Viscous/Slow | Light Cream | 2.2 |
| | | Heavy Cream | 3.5 |
| | | Maple Syrup | 6.8 |
| | | Chocolate Syrup | 9.2 |
| | | Dairy Mixture | 11.7 |
| | | Condensed Milk | 14.0 |
| Amount of Particles | The amount of particles perceived | Miracle Whip | 0.0 |
| | in the sample. | Silk | 0.0 |
| | No particles---Many particles | Sour cream + cream of wheat | 5.0 |
| | | Mayo + corn flour | 10.0 |
| Particle Size | The size of the particles perceived in the | Add each to vanilla pudding in a 1:1 ratio. | |
| | sample, (gritty, grainy, lumpy, etc.) | Silk (no mixing w/pudding) | 0.0 |
| | Very small particles---Very large particles | Vanilla pudding | 0.0 |
| | | Corn starch | 1.0 |
| | | My*T*Fine tapioca pudding mix (dry) | 3.5 |
| | | Grape Nuts | 6.5 |
| | | Uncle Ben's white rice (uncooked) | 9.0 |
| | | Tic Tac's | 14.0 |
| TEN MANIPULATIONS | | | |
| Viscosity at | The rate of flow per unit force | Water | 1.0 |
| 10 Manipulations | across tongue. | Plain Silk | 2.0 |
| | Not viscous/Fast---Viscous/Slow | Light Cream | 2.2 |
| | | Heavy Cream | 3.5 |
| | | Maple Syrup | 6.8 |
| | | Chocolate Syrup | 9.2 |
| | | Dairy Mixture | 11.7 |
| | | Condensed Milk | 14.0 |
| Mixes with Saliva | The saliva solubility of the product. | JIF Peanut Butter (smooth) | 5.0 |
| | No mixing---Complete mixing | Mashed Potatoes | 10.0 |
| | | Jello Chocolate Pudding | 13.5 |
| RESIDUAL | | | |
| Chalky Mouthcoating | The amount of coating/film remaining in | Silk (Chalky, Tacky) | 1.0 |
| | the mouth after expectoration associated | Cooked corn starch | 3.0 |
| | with chalky products such as milk of | Pureed potato | 8.0 |
| | magnesia. | Naked Protein Zone | 14.0 |
| | None---A lot | | |
| Slick Mouthcoating | The amount of coating/film remaining in | Silk (Chalky, Tacky) | 1.0 |
| | the mouth after expectoration associated | Cooked corn starch | 3.0 |
| | with slick products such as over-ripe | Pureed potato | 8.0 |
| | fruit. | Naked Protein Zone | 14.0 |
| | None---A lot | | |
| Tacky Mouthcoating | The amount of coating/film remaining in | Silk (Chalky, Tacky) | 1.0 |
| | the mouth after expectoration associated | Cooked corn starch | 3.0 |
| | with tacky products such as | Pureed potato | 8.0 |
| | marshmallow fluff. | Naked Protein Zone | 14.0 |
| | None---A lot | | |

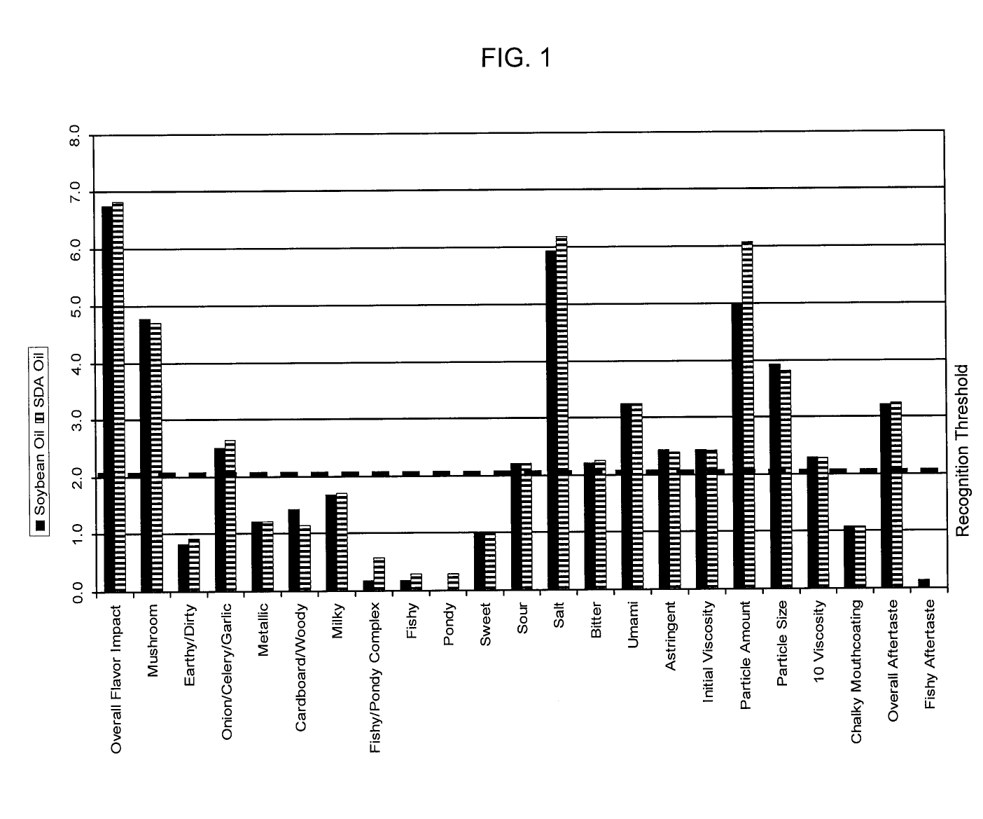

There were detectable differences between the soybean oil and SDA oil condensed cream soup, shown in Table 4. The soybean oil condensed soup was lower in Particle Amount (FIG. 1).

The soybean oil and SDA oil condensed soups had Fishy/Pondy aromatics, but were below the recognition threshold (2.0), meaning that consumers would not be able to detect these aromatics in the samples.

TABLE 4
Flavor, Texture, and Aftertaste Attributes
for the Condensed Cream Soup

| | Soybean | SDA | |
|---|---|---|---|
| Aromatics | Oil | Oil | p value |
| Overall Flavor | 6.8 a | 6.8 a | NS |
| Impact | | | |
| Mushroom | 4.8 a | 4.7 a | NS |
| Earthy/Dirty | 0.8 a | 0.9 a | NS |
| Musty | 0.1 a | 0.0 a | NS |
| Onion/Celery/Garlic | 2.5 a | 2.6 a | NS |
| Grain | 0.0 | 0.0 | n/a |
| Metallic | 1.2 a | 1.2 a | NS |
| Cardboard/Woody | 1.4 a | 1.1 a | * |
| Milky | 1.7 a | 1.7 a | NS |
| Fishy/Pondy | 0.2 a | 0.6 a | NS |
| Complex | | | |
| Fishy | 0.2 a | 0.3 a | NS |
| Pondy | 0.0 a | 0.3 a | NS |
| Other Aromatic: | | 2.3 (43%) | |
| Pepper | | | |
| Basic Tastes & | | | |
| Feeling Factors | | | |
| Sweet | 1.0 a | 1.0 a | NS |
| Sour | 2.2 a | 2.2 a | NS |
| Salt | 5.9 a | 6.2 a | NS |
| Bitter | 2.2 a | 2.3 a | NS |
| Umami | 3.3 a | 3.3 a | NS |
| Astringent | 2.4 a | 2.4 a | NS |
| Burn | 0.1 a | 0.3 a | NS |
| Texture & Mouthfeel | | | |
| Initial Viscosity | 2.44 a | 2.42 a | NS |
| Particle Amount | 5.0 b | 6.1 a | *** |
| Particle Size | 3.9 a | 3.8 a | NS |
| 10 Viscosity | 2.30 a | 2.28 a | NS |
| Mixes with Saliva | 13.7 a | 13.7 a | NS |
| Chalky Mouthcoating | 1.1 a | 1.1 a | NS |
| Slick Mouthcoating | 0.0 | 0.0 | n/a |
| Tacky Mouthcoating | 0.1 a | 0.1 a | NS |
| Aftertaste | | | |
| Overall Aftertaste | 3.2 a | 3.3 a | NS |
| Fishy Aftertaste | 0.1 a | 0.0 a | NS |
| Pondy Aftertaste | 0.0 | 0.0 | n/a |

Means in the same row followed by the same letter are not significantly different at 95% Confidence.
*** 99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 3

### Acceptance of Condensed Cream Soup

To evaluate sensory parity of soybean oil and SDA oil, consumer acceptability based on soybean oil and SDA oil was analyzed for condensed cream soup. The acceptance ratings were compared between the soybean oil and SDA oil condensed cream soup.

The samples were evaluated by 31 consumers willing to try cream of mushroom soup. The judges used a 9-point Hedonic acceptance scale. The Hedonic scale ranged from 1 being dislike extremely to 9 being like extremely and was used for Overall Liking, Appearance Liking, Flavor Liking, Thickness Liking, and Aftertaste Liking.

Consumers evaluated 4 ounces of soup served in 5 ounce bowls. In a saucepan, the samples were diluted by combining 1 can condensed cream soup with 1 can of water, using the same can as the condensed cream soup was in. The saucepan was placed on the stove in which the samples were whisked until smooth then stirred as needed on medium to low heat until the condensed cream soup was heated to 71° C. (160° F.), which took approximately 12 minutes. The samples were presented monadically in duplicate.

The data were analyzed using the Analysis of Variance (ANOVA) to account for panelist and sample effects, with mean separations using Tukey's Significant Difference (HSD) Test.

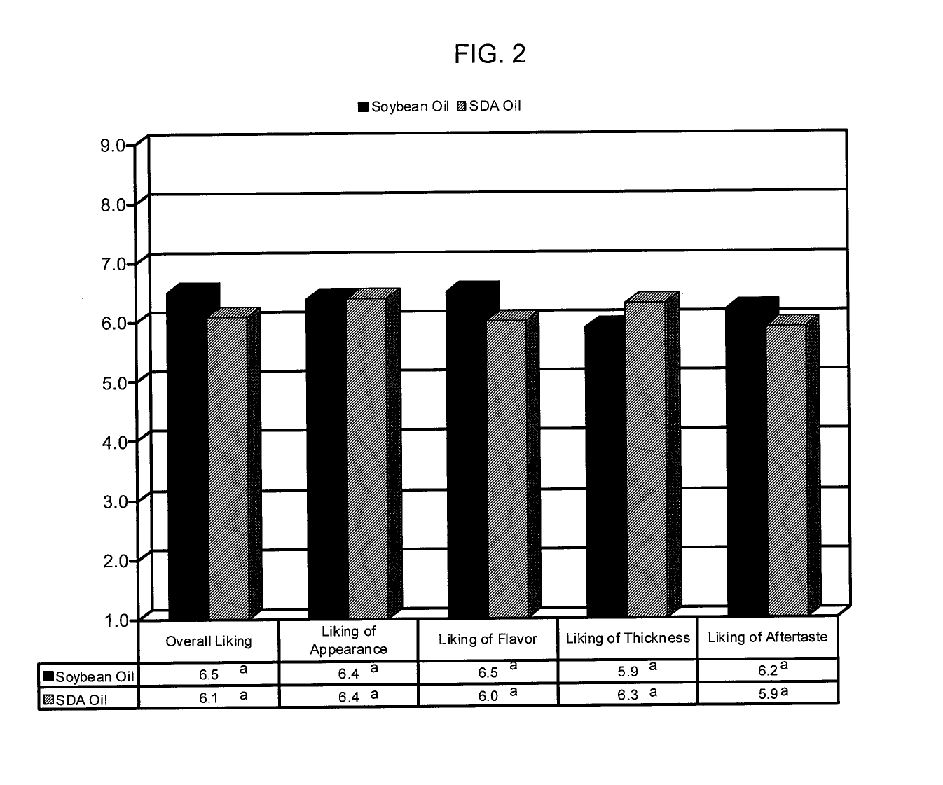

There were no significant differences between the soybean oil and SDA oil in Overall Liking, Appearance Liking, Flavor Liking, and Aftertaste Liking (FIG. 2).

### Example 4

### Gravy Sauce

This example is drawn to a mixture of soybean oil and SDA oil. Gravy is produced by mixing oil and flour and heating the mixture until it begins to brown then adding the broth to the mixture in stages while continuing to heat, stirring constantly until homogeneous. The seasonings are then stirred into the sauce. Cooking continues until the sauce thickens. The ingredients in the gravy are shown in Table 5.

TABLE 5
Gravy sauce containing SDA-enriched Soybean Oil

| Ingredients | g | % |
|---|---|---|
| Broth | 466.00 | 86.00 |
| Seasonings | 2.00 | 0.40 |
| Soybean oil | 43.00 | 7.90 |
| SDA enriched soybean oil | 16.99 | 3.06 |
| Stabilizing Agent | 0.01 | 0.04 |
| Flour | 14.00 | 2.60 |
| Total | 542.00 | 100.00 |

### Example 5

### Pesto Sauce

Basil, garlic, and pine nuts are combined in a food processor and processed until finely chopped, Table 6. Olive oil and SDA oil are combined and added to the food processor while running, being careful to slowly add the oil mixture to the chopped mixture, and regularly scraping the sides of the processor. Finally, cheese and salt are added and combined with the mixture. The result is a pesto sauce that retains the taste, aroma, and mouthfeel of typical pesto sauces on the market with the exception that the product delivers a substantial amount of omega-3.

TABLE 6
Pesto sauce formulation containing SDA-enriched Soybean oil

| Ingredients | % |
|---|---|
| Fresh basil leaves | 9.20 |
| Garlic cloves, chopped | 4.50 |
| Pine nuts | 9.00 |
| Olive oil | 53.60 |
| Parmesan cheese, grated | 20.00 |
| Salt | 0.50 |
| SDA enriched soybean oil | 3.16 |
| Stabilizing Agent | 0.04 |
| Total | 100.00 |

### Example 6

### Vegetable Broth

In a large stainless steel steam jacketed kettle (Model TDA-20, Groen Corp.) a commercial vegetable broth was added and heated to 60° C. (140° F.), formulation according to Table 7. In a separate container, SDA oil was preheated to 49° C. (120° F.) and then blended with the mono- and di-glycerides. The SDA oil/emulsifier blend was dispersed in the vegetable broth to form an emulsion blend. The mixture was then heated to 77° C.-82° C. (170-180° F.) and held at this temperature for 5 minutes to activate the emulsifier. A vegetable extract powder was dispersed in the broth emulsion for additional flavor. The broth emulsion mixture was then homogenized using a two stage process at 2500 psi (180 bar) for the first stage, and at 500 psi (35 bar) for the second stage. The mixture was returned to the kettle and heated to 82° C. (180° F.) for 1 minute to batch pasteurize. It was then collected in hot fill 500 ml bottles, which were allowed to rest for 5 minutes to sterilize the bottles before placing in ice water for 15 minutes to cool. The sterilized product was then stored in the refrigerator until further use.

The result was a vegetable broth that had an increased amount of n-3 PUFAs, but retained the taste, structure, aroma, and mouthfeel of typical broth products currently on the market.

TABLE 7
Vegetable broth formulation containing SDA-enriched Soybean oil

| | | | SDA-enriched | |
|---|---|---|---|---|
| | Soybean Oil | | Soybean Oil | |
| Ingredients | (%) | (g) | (%) | (g) |
| Vegetable broth | 98.855 | 9885.50 | 98.855 | 9885.50 |
| Soybean oil | 0.820 | 82.00 | 0.000 | 0.00 |
| SDA enriched soybean oil | 0.000 | 0.00 | 0.820 | 82.00 |
| (including 0.0081 g | | | | |
| stabilizing agent) | | | | |
| Mono- and Di-glycerides | 0.125 | 12.50 | 0.125 | 12.50 |
| Vegetable extract powder | 0.200 | 20.00 | 0.200 | 20.00. |
| Total | 100.000 | 10000.00 | 100.000 | 10000.00 |

### Example 7

### Profiling of Vegetable Broth

Sensory descriptive analysis was conducted on vegetable broth to understand the attribute differences of soybean oil and SDA oil in vegetable broth. Nine panelists trained in the Sensory Spectrum™ Descriptive Profiling method evaluated the samples for 28 flavor attributes and 3 aftertaste attributes. The attributes were evaluated on a 15-point scale, with 0=none/not applicable and 15=very strong/high in each sample. Definitions of the flavor attributes are given in Table 8.

The samples were heated in a saucepan on medium to low heat until the vegetable broth was warm, samples were kept in a water bath until served and were served at approximately 60° C. (140° F.). Each panelist received 4 ounces of vegetable broth in 5 ounce bowls. The samples were presented monadically in triplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 8
Flavor Attribute Lexicon

| Attribute | Definition | Reference | |
|---|---|---|---|
| Aromatics | | Intensities based on | |
| | | Universal Scale: | |
| | | Baking Soda in | 2.5 |
| | | Saltine | |
| | | Cooked Apple in | 5.0 |
| | | Applesauce | |
| | | Orange in | 7.5 |
| | | Orange Juice | |
| | | Concord Grape in | 10.0 |
| | | Grape Juice | |
| | | Cinnamon in | 12.0 |
| | | Big Red Gum | |
| Overall Flavor | The overall intensity of the product aromas, | | |
| Impact | an amalgamation of all perceived aromatics, | | |
| | basic tastes and chemical feeling factors. | | |
| Vegetable Complex | | | |
| Carrot | The aromatics associated with cooked carrots | canned carrots | |
| Celery | The aromatics associated with cooked celery | Cooked Celery | |
| Mushroom | The aromatic associated with earthy/dirty, | Canned Mushroom Pieces | |
| | musty, woody characteristic of a mushroom. | | |
| Squash | The aromatics associated with raw squash | (Z)-4-Heptenal, Pumpkin, | |
| | meat and seeds. | Zucchini | |
| Other Vegetable | | | |
| Beef | The general category used to describe the | Beef bouillon cube | |
| | total beef flavor impact of the product | | |
| Chicken | The general category used to describe the | Chicken bouillon cube | |
| | total chicken impact. | | |
| Brown/Roasted/ | The aromatic associated with the outside of | Broiled meat, roasted chicken | |
| Caramelized | grilled or broiled meat. | breast | |
| Onion/Garlic | The aromatics associated with dehydrated | Onion, garlic powder | |
| | onion, garlic powders | solutions. Garlic Oil | |
| | | Capsules | |
| White/black pepper | The aromatic associated with white and | White pepper and black | |
| | black pepper | pepper solutions | |
| Other Spice | | | |
| Smoke | The aromatic associated with of any type | Colgin Natural Hickory | |
| | of smoke flavor. | Liquid Smoke | |
| Metallic | The aromatic associated with metals, tin | Iron tablet, canned tomato | |
| | or iron. | juice | |
| Musty/Dirty | Aromatic associated with closed air spaces | Damp cloth stored in plastic | |
| | such as attics and closets (dry) and | bag, old books, white | |
| | basements (wet)./Aromatic characteristic | pepper/Damp potting soil, | |
| | of dry mud, dirt, or soil, and damp soil | dirt | |
| | wet foliage, or slightly undercooked | | |
| | boiled potato. | | |
| Cardboard/Woody | The aromatics associated with dried wood | Toothpicks, Water from | |
| | and the aromatics associated with slightly | cardboard soaked for 1 hour | |
| | oxidized fats and oils, reminiscent of a | | |
| | cardboard box. | | |
| Fishy/Pondy | The aroma/aromatics associated with | | |
| Complex | trimethylamine, pond water or aged fish. | | |
| | The general term used to describe fish | | |
| | meat, which cannot be tied to a specific | | |
| | fish by name. | | |
| Fishy | Aromatic associated with trimethylamine | Cod liver oil capsules, Geisha | |
| | and old fish. | canned lump crab, tuna in | |
| | | pouch | |
| Pondy | The aromas and aromatics associated with | Algal oil (Martek 30% DHA | |
| | water containing algae, reminiscent of | oil) | |
| | pond water and aquatic tanks. | | |
| BASIC TASTES | | | |
| Sweet | The taste on the tongue stimulated by | Sucrose solution: | |
| | sucrose and other sugars, such as | 2% | 2.0 |
| | fructose, glucose, etc., and by other | 5% | 5.0 |
| | sweet substances, such as saccharin, | 10% | 10.0 |
| | Aspartame, and Acesulfam-K. | 16% | 15.0 |
| Sour | The taste on the tongue stimulated by | Citric acid solution: | |
| | acid, such as citric, malic, phosphoric, | 0.05% | 2.0 |
| | etc. | 0.08% | 5.0 |
| | | 0.15% | 10.0 |
| | | 0.20% | 15.0 |
| Salt | The taste on the tongue associated with | Sodium chloride solution: | |
| | sodium salts. | 0.2% | 2.0 |
| | | 0.35% | 5.0 |
| | | 0.5% | 8.5 |
| | | 0.57% | 10.0 |
| | | 0.7% | 16.0 |
| Bitter | The taste on the tongue associated with | Caffeine solution: | |
| | caffeine and other bitter substances, such | 0.05% | 2.0 |
| | as quinine and hop bitters. | 0.08% | 5.0 |
| | | 0.15% | 10.0 |
| | | 0.20% | 15.0 |
| Umami | The taste on the tongue associated with | MSG solution | |
| | monosodium glutamate. Savory. | 6% | 5.0: |
| CHEMICAL FEELING | | | |
| FACTOR | | | |
| Astringent | The shrinking or puckering of the tongue | Alum solution: | |
| | surface caused by substances such as | 0.05% | 3.0 |
| | tannins or alum. | 0.10% | 6.0 |
| | | 0.2% | 9.0 |

| | | |
|---|---|---|
| Burn | A chemical feeling factor associated | Lemon juice, vinegar |
| | with high concentration of irritants to the | |
| | mucous membranes of the oral cavity. | |

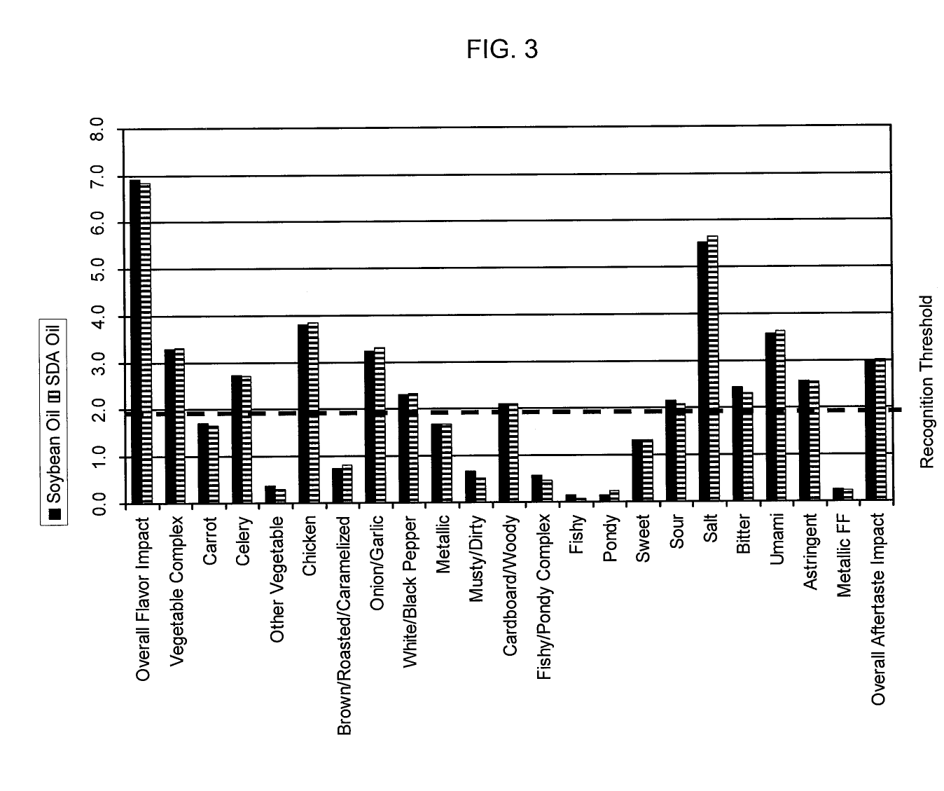

There were detectable differences between the soybean oil and SDA oil vegetable broth, shown in Table 9. The soybean oil and SDA oil had similar profiles, except the soybean oil vegetable broth was significantly higher in Bitter basic taste (FIG. 3). The Fishy/Pondy aromatics in the soybean oil and SDA oil samples were below the recognition threshold (2.0), therefore consumers would not be able to detect these aromatics in the samples.

TABLE 9
Flavor and Aftertaste Attributes for the Vegetable Broth

| | Soybean | SDA | HSD | |
|---|---|---|---|---|
| Aromatics | Oil | Oil | value | p value |
| Overall Flavor | 6.9 a | 6.9 a | 0.171 | NS |
| Impact | | | | |
| Vegetable Complex | 3.3 a | 3.3 a | 0.087 | NS |
| Carrot | 1.7 a | 1.7 a | 0.224 | NS |
| Celery | 2.7 a | 2.7 a | 0.116 | NS |
| Mushroom | 0.0 | 0.0 | n/a | n/a |
| Squash | 0.0 | 0.0 | n/a | n/a |
| Other Vegetable | 0.4 a | 0.3 a | 0.267 | NS |
| Beef | 0.0 | 0.0 | n/a | n/a |
| Chicken | 3.8 a | 3.9 a | 0.173 | NS |
| Brown/Roasted/ | 0.7 a | 0.8 a | 0.267 | NS |
| Caramelized | | | | |
| Onion/Garlic | 3.2 a | 3.3 a | 0.224 | NS |
| White/Black Pepper | 2.3 a | 2.3 a | 0.122 | NS |
| Other Spice | 0.0 | 0.0 | n/a | n/a |
| Smoke | 0.0 | 0.0 | n/a | n/a |
| Metallic | 1.7 a | 1.7 a | 0.078 | NS |
| Musty/Dirty | 0.7 a | 0.5 a | 0.435 | NS |
| Cardboard/Woody | 2.1 a | 2.1 a | n/a | NS |
| Fishy/Pondy Complex | 0.6 a | 0.5 a | 0.362 | NS |
| Fishy | 0.2 a | 0.1 a | 0.267 | NS |
| Pondy | 0.2 a | 0.2 a | 0.291 | NS |
| Basic Tastes & | | | | |
| Feeling Factors | | | | |
| Sweet | 1.3 a | 1.3 a | n/a | NS |
| Sour | 2.2 a | 2.1 a | 0.084 | NS |
| Salt | 5.5 a | 5.7 a | 0.179 | NS |
| Bitter | 2.4 a | 2.3 b | 0.084 | ** |
| Umami | 3.6 a | 3.6 a | 0.138 | NS |
| Astringent | 2.6 a | 2.5 a | 0.038 | NS |
| Metallic FF | 0.3 a | 0.2 a | 0.038 | NS |
| Burn | 0.0 | 0.0 | n/a | n/a |
| Aftertaste | | | | |
| Overall Aftertaste | 3.0 a | 3.0 a | 0.109 | NS |
| Impact | | | | |
| Fishy Aftertaste | 0.0 | 0.0 | n/a | n/a |
| Pondy Aftertaste | 0.0 | 0.0 | n/a | n/a |

Means in the same row followed by the same letter are not significantly different at 95% Confidence.
*** 99% Confidence,
** 95% Confidence,
* 90% Confidence,
NS—Not Significant
The attributes above threshold are bold.
For other attributes, % score is the percentage of times the attribute was perceived, and the score is reported as an average value of the detectors.

### Example 8

### Acceptance of Vegetable Broth

To evaluate sensory parity of soybean oil and SDA oil consumer acceptability based on soybean oil and SDA oil were analyzed of vegetable broth. The acceptance ratings were compared between the soybean oil and SDA oil vegetable broth.

The samples were evaluated by 58 consumers willing to try vegetable broth. The judges used a 9-point Hedonic acceptance scale. The Hedonic scale ranged from 1 being dislike extremely to 9 being like extremely and was used for Overall Liking, Color Liking, Flavor Liking, Mouthfeel Liking, Thickness Liking, and Aftertaste Liking.

Consumers evaluated 4 ounces of vegetable broth served in 5 ounce bowls. The samples were heated in a saucepan on medium to low heat until the vegetable broth was warm. Samples were kept in a water bath until served and were served at approximately 60° C. (140° F.). The samples were served by sequential monadic presentation (one at a time).

The data were analyzed using the Analysis of Variance (ANOVA) to account for panelist and sample effects, with mean separations using Tukey's Significant Difference (HSD) Test.

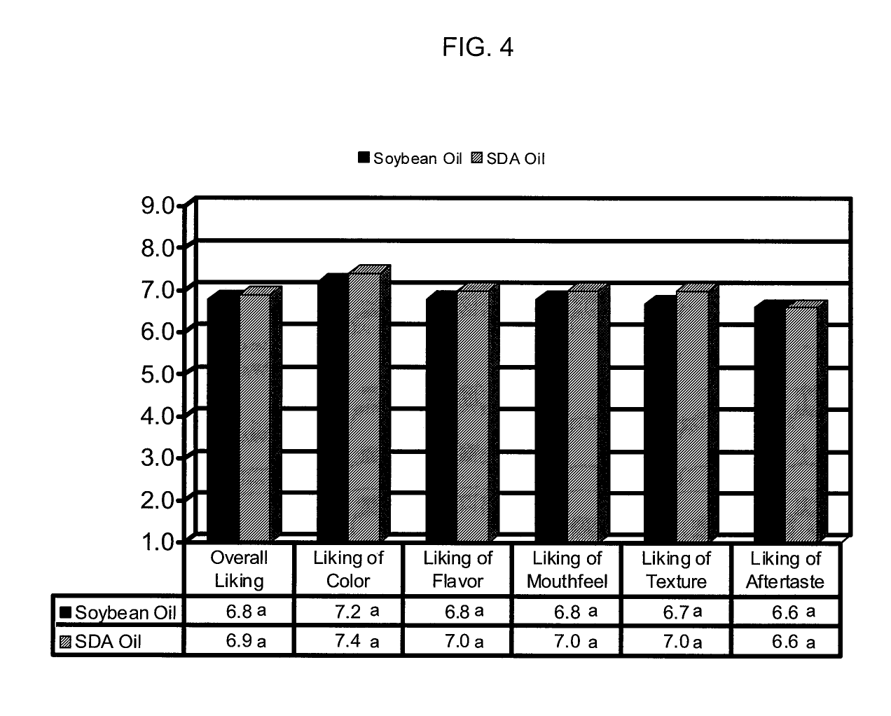

There were no significant differences between the soybean oil and SDA oil vegetable broth in Overall Liking, Color Liking, Flavor Liking, Mouthfeel Liking, and Aftertaste Liking (FIG. 4).

### Example 9

### Sweet and Sour Sauce

The white vinegar and starch are whisked together over medium heat until thoroughly blended. The remaining ingredients from Table 10 below are added and blended. The mixture is heated until the sauce thickens. The result is a sweet and sour sauce that retains the taste, aroma, and mouthfeel of the typical sweet and sour sauces on the market with the exception that the product delivers a substantial amount of omega-3. At a cook yield of 90%, 380 mg SDA is delivered per serving of sweet and sour sauce.

TABLE 10
Sweet and sour sauce formulation containing
SDA-enriched soybean oil

| | | | SDA-enriched | |
|---|---|---|---|---|
| | Soybean oil | | soybean oil | |
| Ingredients: | (%) | (g) | (%) | (g) |
| White Vinegar | 24.30 | 728.94 | 24.30 | 728.94 |
| Pineapple Juice | 48.60 | 1457.89 | 48.60 | 1457.89 |
| Brown Sugar | 13.55 | 406.59 | 13.55 | 406.59 |
| Ketchup | 9.04 | 271.06 | 9.04 | 271.06 |
| Modified food starch | 1.51 | 45.18 | 1.51 | 45.18 |
| SDA enriched soybean oil | 0.00 | 0.00 | 2.96 | 90.31 |
| Stabilizing Agent | 0.00 | 0.00 | 0.04 | 0.03 |
| Soybean oil | 3.00 | 90.34 | 0.00 | 0.00 |
| Total | 100.00 | 3000.00 | 100.00 | 3000.00 |

### Example 10

### Sun Dried Tomatoes in Olive Oil and SDA Oil

Boiling water is poured into a large bowl containing julienned sun dried tomatoes, Table 11. This is allowed to stand for 10 minutes, before the tomatoes are drained and patted dry. Olive oil and SDA oil are mixed in a bowl, and set aside. The wine and tomato paste are mixed in another bowl and set aside. All ingredients are divided into three portions and each portion placed into a 12 oz jar and shaken well to mix. The oil mixture is poured into each jar and tightly sealed. The jars are allowed to rest for 2 weeks under refrigeration to develop the flavor of the product. The result is a product that retains the taste, aroma, and mouthfeel of the typical sundried tomato oil infusion products on the market with the exception that the product delivers a substantial amount of omega-3 per 30 g serving.

TABLE 11
Sun dried tomatoes in olive oil and
SDA-enriched soybean oil formulation

| Ingredients | (%) | (g) |
|---|---|---|
| Sun dried tomatoes, hydrated | 37.6% | 1127.82 |
| Olive oil | 47.0% | 1409.77 |
| SDA enriched oil | 6.03% | 183.13 |
| Stabilizing Agent | 0.07 | 0.134 |
| Rosemary, fresh | 0.6% | 16.92 |
| Thyme, fresh | 0.4% | 11.28 |
| Minced Garlic | 0.9% | 28.20 |
| Bay leaves | 0.4% | 11.28 |
| Red wine vinegar | 1.4% | 42.29 |
| Black olives, sliced | 2.8% | 84.59 |
| Tomato paste | 2.8% | 84.59 |
| Total | 100.0% | 3000.00 |

### Example 11

### Basic Cream Sauce

A roux was made with butter, oil and flour heated until the flour was cooked. The pan was removed from the heat, and the milk was added to the mixture and stirred. The pan was returned to the heat and cooked until the sauce was thick and smooth. Cream and seasonings were added as listed in Table 12. The result was a cream sauce that had an increased amount of n-3 PUFAs, but retained the taste, structure, aroma, and mouthfeel of typical cream sauce products currently on the market. The product delivered a substantial amount of omega-3 per 60 g serving size.

TABLE 12
Basic cream sauce formulation containing
SDA-enriched soybean oil

| | | | SDA-enriched | |
|---|---|---|---|---|
| | Soybean Oil | | Soybean Oil | |
| Ingredients | (%) | (g) | (%) | (g) |
| Whole milk | 66.40 | 7968.00 | 66.40 | 7968.00 |
| Butter | 1.49 | 178.80 | 1.49 | 178.80 |
| Flour | 4.20 | 504.00 | 4.20 | 504.00 |
| White pepper | 0.04 | 4.80 | 0.04 | 4.80 |
| Salt | 0.31 | 37.20 | 0.31 | 37.20 |
| Heavy cream | 24.55 | 2947.20 | 24.55 | 2947.20 |
| Soybean oil | 2.89 | 346.80 | 0.00 | 0.00 |
| SDA enriched oil | 0.00 | 0.00 | 2.87 | 346.68 |
| Stabilizing Agent | 0.00 | 0.00 | 0.03 | 0.12 |
| Mono and di-glycerides | 0.11 | 13.20 | 0.11 | 13.20 |
| Total | 100.00 | 12000.00 | 100.00 | 12000.00 |

### Example 12

### Profiling of Basic Cream Sauce

Sensory descriptive analysis was conducted on basic cream sauce to understand the attribute differences of soybean oil and SDA oil in basic cream sauce. Eight panelists trained in the Sensory Spectrum™ Descriptive Profiling method evaluated the samples for 16 flavor attributes, 2 texture attributes, and 3 aftertaste attributes. The attributes were evaluated on a 15-point scale, with 0=none/not applicable and 15=very strong/high in each sample. Definitions of the flavor attributes are given in Table 13 and texture attributes are give in Table 14.

The samples were heated in a saucepan on medium to low heat until the basic cream sauce was warm, samples were kept in a water bath until served, and samples were served at approximately 60° C. (140° F.). Each panelist received 4 ounces of basic cream sauce in 5 ounce bowls. The samples were presented monadically in triplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 13
Flavor Attribute Lexicon

| Attribute | Definition | Reference | |
|---|---|---|---|
| Aromatics | | Intensities based on | |
| | | Universal Scale: | |
| | | Baking Soda in | 2.5 |
| | | Saltine | |
| | | Cooked Apple in | 5.0 |
| | | Applesauce | |
| | | Orange in | 7.5 |
| | | Orange Juice | |
| | | Concord Grape in | 10.0 |
| | | Grape Juice | |
| | | Cinnamon in | 12.0 |
| | | Big Red Gum | |
| Overall Flavor | The overall intensity of the product aromas, | | |
| Impact | an amalgamation of all perceived aromatics, | | |
| | basic tastes and chemical feeling factors. | | |
| Cheese | The aromatics associated with hard cheeses | Parmesan cheese, Romano | |
| | (parmesan, Romano, etc. | Cheese | |
| Dairy | The aromatics associated with milk derived | 2% Milk | |
| | products - includes protein and fat | | |
| | aromatics. | | |
| Onion/Garlic | The aromatics associated with dehydrated | Onion and garlic powder | |
| | onion and garlic powders. | solutions | |
| White/black pepper | The aromatic associated with white and | White pepper and black pepper | |
| | black pepper | solutions | |
| Grain | The aromatics associated with total grain | All-purpose flour paste, cream | |
| | impact, which may include all types of | of wheat, whole wheat pasta, | |
| | grain at different stages of heating. May | rice noodles | |
| | include wheat, whole wheat, oat, rice, | | |
| | graham, etc. | | |
| Cardboard/Woody | The aromatics associated with dried wood | Toothpicks, Water from | |
| | and the aromatics associated with slightly | cardboard soaked for 1 hour | |
| | oxidized fats and oils, reminiscent of a | | |
| | cardboard box. | | |
| Fishy/Pondy | The aroma/aromatics associated with | | |
| Complex | triethylamine, pond water or aged fish. The | | |
| | general term used to describe fish meat, | | |
| | which cannot be tied to a specific fish by | | |
| | name. | | |
| Fishy | Aromatic associated with trimethylamine | Cod liver oil capsules, | |
| | and old fish. | trimethylamine, Geisha canned | |
| | | lump crab, tuna in pouch | |
| Pondy | The aromas and aromatics associated with | Algal oil (Martek 30% DHA | |
| | water containing algae, reminiscent of pond | oil) | |
| | water and aquatic tanks. | | |
| BASIC TASTES | | | |
| Sweet | The taste on the tongue stimulated by | Sucrose solution: | |
| | sucrose and other sugars, such as | 2% | 2.0 |
| | fructose, glucose, etc., and by other | 5% | 5.0 |
| | sweet substances, such as saccharin, | 10% | 10.0 |
| | Aspartame, and Acesulfam-K. | 16% | 15.0 |
| Sour | The taste on the tongue stimulated by | Citric acid solution: | |
| | acid, such as citric, malic, phosphoric, | 0.05% | 2.0 |
| | etc. | 0.08% | 5.0 |
| | | 0.15% | 10.0 |
| | | 0.20% | 15.0 |
| Salt | The taste on the tongue associated with | Sodium chloride solution: | |
| | sodium salts. | 0.2% | 2.0 |
| | | 0.35% | 5.0 |
| | | 0.5% | 8.5 |
| | | 0.57% | 10.0 |
| | | 0.7% | 16.0 |
| Bitter | The taste on the tongue associated with | Caffeine solution: | |
| | caffeine and other bitter substances, such | 0.05% | 2.0 |
| | as quinine and hop bitters. | 0.08% | 5.0 |
| | | 0.15% | 10.0 |
| | | 0.20% | 15.0 |
| Umami | The taste on the tongue associated with | MSG solution | |
| | monosodium glutamate. Savory. | 6% | 5.0: |
| CHEMICAL FEELING | | | |
| FACTOR | | | |
| Astringent | The shrinking or puckering of the tongue | Alum solution: | |
| | surface caused by substances such as | 0.05% | 3.0 |
| | tannins or alum. | 0.10% | 6.0 |
| | | 0.2% | 9.0 |

| | | |
|---|---|---|
| Burn | A chemical feeling factor associated | Lemon juice, vinegar |
| | with high concentration of irritants to the | |
| | mucous membranes of the oral cavity. | |

TABLE 14
Texture Attribute Lexicon

| Attribute | Definition | Reference Scale | |
|---|---|---|---|
| INITIAL | | | |
| Initial Viscosity | The rate of flow per unit force | Water | 1.0 |
| | across tongue. | Plain Silk | 2.0 |
| | Not viscous/Fast---Viscous/Slow | Light Cream | 2.2 |
| | | Heavy Cream | 3.5 |
| | | Maple Syrup | 6.8 |
| | | Chocolate Syrup | 9.2 |
| | | Dairy Mixture | 11.7 |
| | | Condensed Milk | 14.0 |
| TEN MANIPULATIONS | | | |
| Viscosity at | The rate of flow per unit force | Water | 1.0 |
| 10 Manipulations | across tongue. | Light Cream | 2.2 |
| | Not viscous/Fast---Viscous/Slow | Plain Silk | 2.5 |
| | | Heavy Cream | 3.5 |
| | | Maple Syrup | 6.8 |
| | | Chocolate Syrup | 9.2 |
| | | Dairy Mixture | 11.7 |
| | | Condensed Milk | 14.0 |

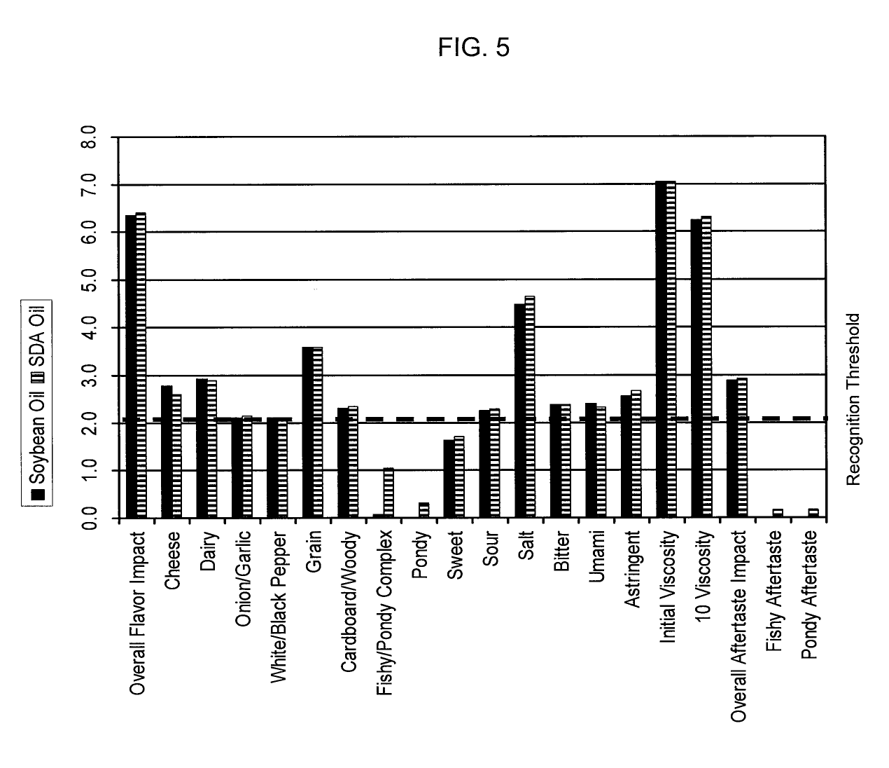

There were detectable differences between the soybean oil and SDA oil basic cream sauce, shown in Table 15. The soybean oil and SDA oil had similar profiles, except the SDA oil basic cream sauce sample was significantly higher in Fishy/Pondy Complex and Astringent basic taste (FIG. 5). The Fishy/Pondy aromatics in the SDA oil sample were still below the recognition threshold (2.0), therefore consumers would not be able to detect these aromatics in the sample.

TABLE 15
Flavor, Texture, and Aftertaste Attributes for Basic Cream Sauce

| | SDA | Soybean | HSD | |
|---|---|---|---|---|
| Aromatics | Oil | Oil | value | p value |
| Overall Flavor Impact | 6.4 a | 6.4 a | 0.186 | NS |
| Cheese | 2.6 a | 2.8 a | 0.270 | NS |
| Dairy | 2.9 a | 2.9 a | 0.076 | NS |
| Onion/Garlic | 2.2 a | 2.1 a | 0.106 | NS |
| White/Black Pepper | 2.1 a | 2.1 a | 0.139 | NS |
| Grain | 3.6 a | 3.6 a | 0.139 | NS |
| Cardboard/Woody | 2.4 a | 2.3 a | 0.060 | NS |
| Fishy/Pondy Complex | 1.0 a | 0.1 b | 0.594 | *** |
| Fishy | 0.0 | 0.0 | n/a | n/a |
| Pondy | 0.3 a | 0.0 a | 0.357 | * |
| Other Aromatic: | 2.5 (35%) | 2.0 (38%) | | |
| Browned/Caramelized | | | | |
| Other Aromatic: | 2.0 (13%) | 2.0 (13%) | | |
| Starchy | | | | |
| Other Aromatic: | | 2.0 (13%) | | |
| Overcooked Milk | | | | |
| Basic Tastes & | | | | |
| Feeling Factors | | | | |
| Sweet | 1.7 a | 1.6 a | 0.102 | NS |
| Sour | 2.3 a | 2.3 a | 0.060 | NS |
| Salt | 4.7 a | 4.5 a | 0.194 | * |
| Bitter | 2.4 a | 2.4 a | 0.108 | NS |
| Umami | 2.3 a | 2.4 a | 0.129 | NS |
| Astringent | 2.7 a | 2.6 b | 0.088 | ** |
| Burn | 0.0 | 0.0 | n/a | n/a |
| Texture & Mouthfeel | | | | |
| Initial Viscosity | 7.05 a | 7.04 a | 0.233 | NS |
| 10 Viscosity | 6.31 a | 6.24 a | 0.214 | NS |
| Aftertaste | | | | |
| Overall Aftertaste | 2.9 a | 2.9 a | 0.098 | NS |
| Impact | | | | |
| Fishy Aftertaste | 0.2 a | 0.0 a | 0.239 | NS |
| Pondy Aftertaste | 0.2 a | 0.0 a | 0.239 | NS |

Means in the same row followed by the same letter are not significantly different at 95% Confidence.
*** 99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 13

### Tomato Based Pasta Sauce

Table 16 is a list of ingredients in percentage (%) by weight and amount used in grams for the Tomato Based Pasta Sauce. In a stainless steel steam jacketed kettle, water and tomato paste were mixed together over moderate speed at ambient temperature. Once the tomato paste was completely hydrated, the temperature was increased to 60° C. (140° F.). The SDA soybean oil was added to the mixture. In a separate container, potato starch was dry blended with sucrose to increase dispersability of the starch. The blend was then added to the tomato emulsion under high agitation, which was then heated to 77° C.-82° C. (170-180° F.) for a hold time of 5 minutes. Salt and the following flavors were then added; garlic, cooked tomato, basil and natural pepper flavor. The pH of the tomato emulsion was adjusted using citric acid to pH3.9. Next the mixture was heated to 82° C. (180° F.) for 1 minute to batch pasteurize. The product was collected in hot fill 500 ml bottles and allowed to rest for 5 minutes in the bottles before placing in an ice bath for 15 minutes to cool. The product was then stored in the refrigerator at 4° C.

The result was a tomato sauce that had an increased amount of n-3 PUFAs, but retained the taste, structure, aroma, and mouthfeel of typical tomato sauce products currently on the market.

TABLE 16
Tomato based pasta sauce formulation
containing SDA-enriched soybean oil

| | | | SDA enriched | |
|---|---|---|---|---|
| | Soybean Oil | | Soybean Oil | |
| | | Amount | | Amount |
| Ingredients | (%) | (g) | (%) | (g) |
| Water | 35.2 | 3516.0 | 35.2 | 3516.0 |
| Tomato Paste | 56.4 | 5640.0 | 56.4 | 5640.0 |
| Soybean Oil | 2.9 | 290.0 | 0.0 | 0.0 |
| SDA enriched Soybean Oil (including | 0.0 | 0.0 | 2.9 | 290.0 |
| 0.1 g stabilizing agent) | | | | |
| Starch | 0.5 | 50.0 | 0.5 | 50.0 |
| Sugar | 1.6 | 160.0 | 1.6 | 160.0 |
| Salt | 1.8 | 180.0 | 1.8 | 180.0 |
| Flavors | 1.6 | 164.0 | 1.6 | 164.0 |
| Total | 100.0 | 10000.0 | 100.0 | 10000.0 |

### Example 14

### Profiling of Tomato Based Pasta Sauce

Sensory descriptive analysis was conducted on tomato based pasta sauce to understand the attribute differences of soybean oil and SDA oil in tomato based pasta sauce. Nine panelists trained in the Sensory Spectrum™ Descriptive Profiling method evaluated the samples for 18 flavor attributes, 2 texture attributes, and 3 aftertaste attributes. The attributes were evaluated on a 15-point scale, with 0=none/not applicable and 15=very strong/high in each sample. Definitions of the flavor attributes are given in Table 17 and texture attributes are give in Table 14.

The samples were heated in a saucepan on medium to low heat until warm. Samples were kept in a water bath until served and were served at 66° C. (150° F.). Each panelist received 4 ounces of tomato based pasta sauce in 5 ounce bowls. The samples were presented monadically in triplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 17
Flavor Attribute Lexicon

| Attribute | Definition | Reference | |
|---|---|---|---|
| Aromatics | | Intensities based on | |
| | | Universal Scale: | |
| | | Baking Soda in | 2.5 |
| | | Saltine | |
| | | Cooked Apple in | 5.0 |
| | | Applesauce | |
| | | Orange in | 7.5 |
| | | Orange Juice | |
| | | Concord Grape in | 10.0 |
| | | Grape Juice | |
| | | Cinnamon in | 12.0 |
| | | Big Red Gum | |
| Overall Flavor | The overall intensity of the product aromas, | | |
| Impact | an amalgamation of all perceived aromatics, | | |
| | basic tastes and chemical feeling factors. | | |
| Tomato | The aromatics associated with tomatoes | Hunt's tomato juice (no salt), | |
| | | canned tomato paste | |
| Green herbs | The aromatics associated with fresh or | Oregano, thyme, basil, bay, | |
| | dried herbs | sage, parsley, etc. | |
| Onion/Garlic/ | The aromatics associated with dehydrated | Onion, garlic and celery | |
| Celery | onion, garlic and celery powders | powder solutions. Garlic Oil | |
| | | Capsules | |
| White/black pepper | The aromatic associated with white and | White pepper and black | |
| | black pepper | pepper solutions | |
| Cardboard/Woody | The aromatics associated with dried wood | Toothpicks, Water from | |
| | and the aromatics associated with slightly | cardboard soaked for 1 hour | |
| | oxidized fats and oils, reminiscent of a | | |
| | cardboard box. | | |
| Fishy/Pondy | The aroma/aromatics associated with | | |
| Complex | triethylamine, pond water or aged fish. | | |
| | The general term used to describe fish | | |
| | meat, which cannot be tied to a specific | | |
| | fish by name. | | |
| Fishy | Aromatic associated with trimethylamine | Cod liver oil capsules, | |
| | and old fish. | trimethylamine, Geisha | |
| | | canned lump crab, tuna in | |
| | | pouch | |
| Pondy | The aromas and aromatics associated with | Algal oil (Martek 30% DHA | |
| | water containing algae, reminiscent of | oil) | |
| | pond water and aquatic tanks. | | |
| Metallic | The aromatic associated with metals, | Iron tablet, canned tomato | |
| | tin or iron. | juice | |
| BASIC TASTES | | | |
| Sweet | The taste on the tongue stimulated by | Sucrose solution: | |
| | sucrose and other sugars, such as | 2% | 2.0 |
| | fructose, glucose, etc., and by other | 5% | 5.0 |
| | sweet substances, such as saccharin, | 10% | 10.0 |
| | Aspartame, and Acesulfam-K. | 16% | 15.0 |
| Sour | The taste on the tongue stimulated by | Citric acid solution: | |
| | acid, such as citric, malic, phosphoric, | 0.05% | 2.0 |
| | etc. | 0.08% | 5.0 |
| | | 0.15% | 10.0 |
| | | 0.20% | 15.0 |
| Salt | The taste on the tongue associated with | Sodium chloride solution: | |
| | sodium salts. | 0.2% | 2.0 |
| | | 0.35% | 5.0 |
| | | 0.5% | 8.5 |
| | | 0.57% | 10.0 |
| | | 0.7% | 16.0 |
| Bitter | The taste on the tongue associated with | Caffeine solution: | |
| | caffeine and other bitter substances, such | 0.05% | 2.0 |
| | as quinine and hop bitters. | 0.08% | 5.0 |
| | | 0.15% | 10.0 |
| | | 0.20% | 15.0 |
| Umami | The taste on the tongue associated with | MSG solution | |
| | monosodium glutamate. Savory. | 6% | 5.0: |
| CHEMICAL FEELING | | | |
| FACTOR | | | |
| Astringent | The shrinking or puckering of the tongue | Alum solution: | |
| | surface caused by substances such as | 0.05% | 3.0 |
| | tannins or alum. | 0.10% | 6.0 |
| | | 0.2% | 9.0 |

| | | |
|---|---|---|
| Burn | A chemical feeling factor associated | Lemon juice, vinegar |
| | with high concentration of irritants to the | |
| | mucous membranes of the oral cavity. | |

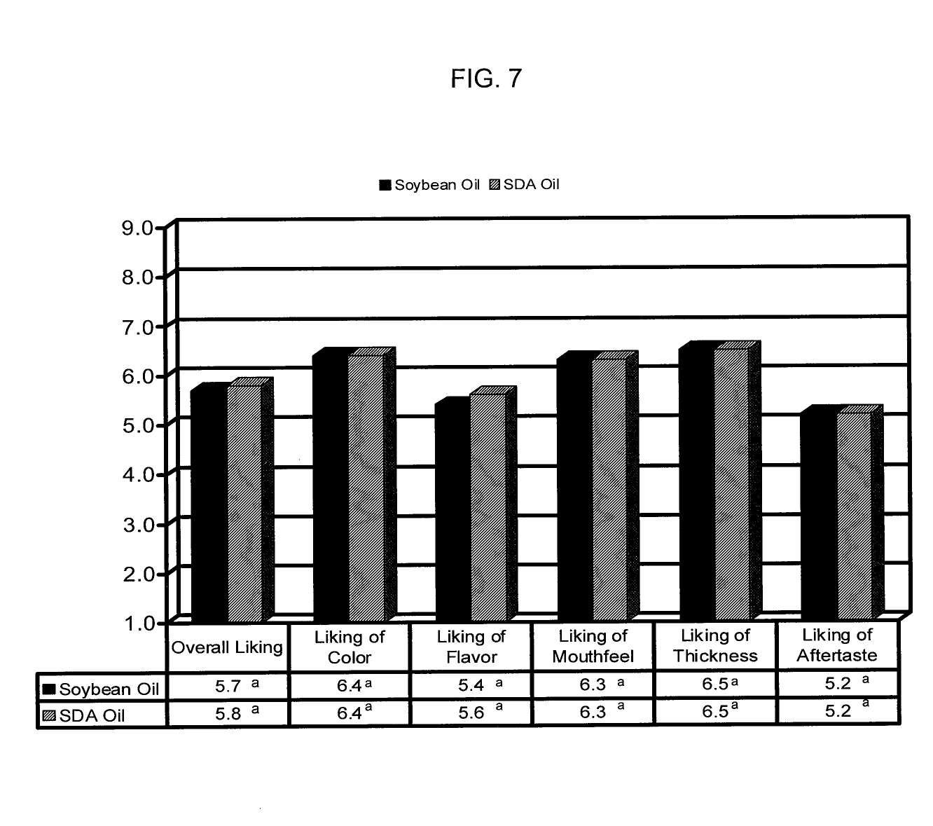

There were detectable differences between the soybean oil and SDA oil tomato based pasta sauce, shown in Table 18. The soybean oil and SDA oil had similar profiles, except the soybean oil tomato based pasta sauce was significantly higher in Green Herb aromatics (FIG. 7).

The SDA oil tomato based pasta sauce was significantly higher in Fishy/Pondy Complex, Metallic aromatics, and 10 Viscosity (FIG. 7). The Fishy/Pondy aromatics in the soybean oil and SDA oil samples were below the recognition threshold (2.0), therefore consumers would not be able to detect these aromatics in the samples.

TABLE 18
Flavor, Texture, and Aftertaste Attributes
for Tomato Based Pasta Sauce

| | Soybean | SDA | HSD | |
|---|---|---|---|---|
| Aromatics | Oil | Oil | value | p value |
| Overall Flavor Impact | 8.7 a | 8.7 a | 0.129 | NS |
| Tomato | 6.6 a | 6.5 a | 0.179 | NS |
| Green Herbs | 3.8 a | 3.6 b | 0.208 | ** |
| Onion/Garlic/Celery | 2.8 a | 2.8 a | 0.087 | NS |
| White/Black Pepper | 2.7 a | 2.6 a | 0.103 | NS |
| Cardboard/Woody | 1.4 a | 1.4 a | n/a | NS |
| Fishy/Pondy Complex | 0.2 b | 1.0 a | 0.427 | *** |
| Fishy | 0.0 | 0.0 | n/a | n/a |
| Pondy | 0.2 a | 0.3 a | 0.067 | NS |
| Metallic | 2.8 b | 3.0 a | 0.136 | *** |
| Basic Tastes & | | | | |
| Feeling Factors | | | | |
| Sweet | 2.9 a | 3.0 a | 0.348 | NS |
| Sour | 3.4 a | 3.5 a | 0.174 | NS |
| Salt | 4.2 a | 4.3 a | 0.100 | NS |
| Bitter | 2.9 a | 2.9 a | 0.094 | NS |
| Umami | 3.0 a | 3.1 a | 0.138 | NS |
| Astringent | 2.9 a | 2.9 a | 0.140 | NS |
| MetallicFF | 1.4 a | 1.3 a | 0.038 | NS |
| Burn | 1.1 a | 1.0 a | 0.426 | NS |
| Texture & Mouthfeel | | | | |
| Initial Viscosity | 6.62 a | 6.59 a | 0.117 | NS |
| 10 Viscosity | 5.19 b | 5.29 a | 0.094 | ** |
| Aftertaste | | | | |
| Overall Aftertaste | 3.6 a | 3.7 a | 0.087 | NS |
| Impact | | | | |
| Fishy Aftertaste | 0.0 | 0.0 | n/a | n/a |
| Pondy Aftertaste | 0.0 | 0.0 | n/a | n/a |

Means in the same row followed by the same letter are not significantly different at 95% Confidence.
*** 99% Confidence,
** 95% Confidence,
* 90% Confidence,
NS—Not Significant
The attributes above threshold are bold.
For other attributes, % score is the percentage of times the attribute was perceived, and the score is reported as an average value of the detectors.

### Example 15

### Acceptance of Tomato Based Pasta Sauce

To evaluate sensory parity of soybean oil and SDA oil consumer acceptability based on soybean oil and SDA oil were analyzed of tomato based pasta sauce. The acceptance ratings were compared between the soybean oil and SDA oil tomato based pasta sauce.

The samples were evaluated by 50 consumers willing to try tomato sauce. The judges used a 9-point Hedonic acceptance scale. The Hedonic scale ranged from 1 being dislike extremely to 9 being like extremely and was used for Overall Liking, Color Liking, Flavor Liking, Mouthfeel Liking, Thickness Liking, and Aftertaste Liking.

Consumers evaluated 4 ounces of tomato based pasta sauce served in 5 ounce bowls. The tomato based pasta sauce was heated in a saucepan on medium to low heat until warm. Samples were kept in a water bath until served and were served at approximately 66° C. (150° F.). The samples were served by sequential monadic presentation (one at a time).

The data were analyzed using the Analysis of Variance (ANOVA) to account for panelist and sample effects, with mean separations using Tukey's Significant Difference (HSD) Test.

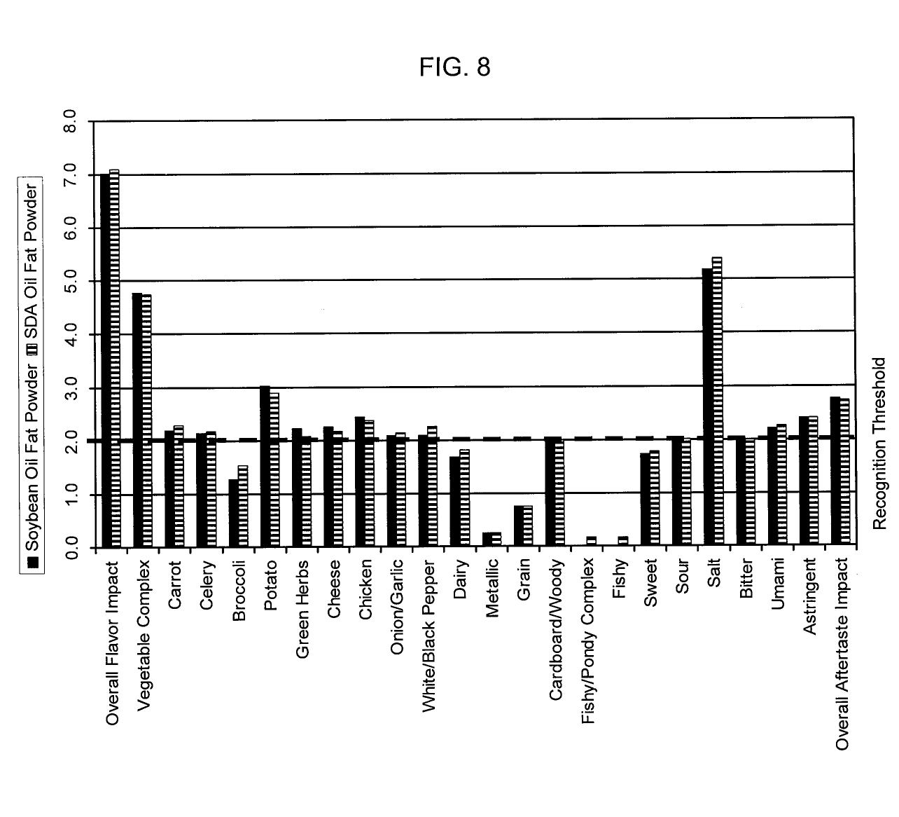

There were no significant differences between the soybean oil and SDA oil tomato based pasta sauce in Overall Liking, Color Liking, Flavor Liking, Mouthfeel Liking, Thickness Liking, and Aftertaste Liking (FIG. 8).

### Example 16

### Fat Powder Compositions

The following example relates to a method for forming a fat powder that contains an amount of SDA enriched soybean oil.

Fat powder was formed according to typical industry processing techniques using the step-by-step process below. Table 19 is the list of ingredients in percentage (%) by weight and amount used in grams.

TABLE 19
Fat powder formulation containing SDA-enriched soybean oil

| | 65% Fat Blend | | 70% Fat Blend |
|---|---|---|---|
| | 30% SDA:35% PO | | 35% SDA:35% PO |
| | | Weight | Weight |
| Ingredient | % | (g) | (g) |
| Distilled Water | 49.20 | 3444.00 | 3269.00 |
| Palm Oil | 17.50 | 1225.00 | 1225.00 |
| SDA Oil | 14.82 | 1048.11 | 1223.11 |
| Stabilizing Agent | 0.18 | 1.89 | 1.89 |
| 25DE Corn Syrup Solids | 15.00 | 1050.00 | 1050.00 |
| Na Caseinate | 2.50 | 175.00 | 175.00 |
| Dipotassium Phosphate | 0.30 | 21.00 | 21.00 |
| Mono- and di-gylcerides | 0.50 | 35.00 | 35.00 |
| Total | 100.00 | 7000.00 | 7000.00 |

The ingredients were combined and processed according to the following steps to produce the fat powders.
1) The palm oil was heated to melting point and the mono- & di-glycerides added to the melted oil and mixed until dissolved.
2) The SDA oil was added to the palm oil mixture and mixed until well blended.
3) The cold water was added to a second tank and dipotassium phosphate added to the water with mixing until dissolved. The water was heated to 60° C. (140° F.).
4) The sodium caseinate was then added to the potassium phosphate solution and heated to 70° C. (160° F.) for 10 to 15 minutes to hydrate the protein.
5) The carbohydrates were added to the sodium caseinate solution and mixed until well dissolved.
6) The oil mixture was added to the protein solution and mixed thoroughly before being homogenized at 150 bar (2200 psi).
7) Using a peristaltic pump and with constant agitation in the tank, the mixture (emulsion) was pumped to the nozzle of a spray dryer, operating at 190° C. (375° F.) inlet temperature and 80° C. (176° F.) outlet.
8) The resultant fat powder was collected in jars and then transferred to a plastic bag to cool
9) The fat powder was then stored in the refrigerator.

The results were a fat powder that has an increased amount of n-3 PUFAs, but retained the taste, structure, aroma, and mouthfeel of typical fat powders currently produced on the market. The product delivered 1.79 g and 2.08 g SDA per 28.5 g serving of fat powder.

### Example 17

### Dry Blended Soup

The following example relates to a method for forming a dry blended soup that contains an amount of SDA enriched soybean oil.

The dry blended soup was formed according to typical industry processing techniques using the step-by-step process below. Table 20 is the list of ingredients in percentage (%) by weight and amount used in grams.

TABLE 20
Dry blended soup formulation containing SDA-enriched fat powder

| | | | SDA - |
|---|---|---|---|
| | | Soybean Oil | enriched Oil |
| | | fat powder | fat powder |
| Ingredients | % | (g) | (g) |
| Soy protein isolate | 15.00 | 225.00 | 225.00 |
| Non fat dry milk (NFDM) | 15.00 | 225.00 | 225.00 |
| Fat Powder Soybean Oil | 19.00 | 285.0 | 0.00 |
| Fat Powder SDA 7% (including | | 0.00 | 285.00 |
| 0.0455 g Stabilizing Agent) | | | |
| Corn starch | 11.00 | 165.00 | 165.00 |
| Vegetable soup blend | 6.00 | 90.00 | 90.00 |
| Maltodextrin | 21.65 | 324.75 | 324.75 |
| Xantham Gum | 0.350 | 5.25 | 5.25 |
| Cheddar Cheese Powder Blend | 4.00 | 60.00 | 60.00 |
| Seasonings and soup mix | 5.00 | 75.00 | 75.00 |
| Dried Vegetable Blend | 3.00 | 45.00 | 45.00 |
| Total | 100.000 | 1500.000 | 1500.000 |

The ingredients were combined and processed according to the following steps to produce the fat powders.
1) All the ingredients were mixed in a Hobart mixer using a paddle attachment for 20 minutes.
2) The dry blend was then packaged and stored at room temperature until sensory analysis was conducted.
3) For the preparation of the soup for sensory analysis, 60 g of the dry blend was added to 460 g (2 cups) of water and brought to a boil with occasional stirring.
4) The heat was reduced to low and the soup simmered for 10 to 15 minutes.

The result was a dry blended soup that had an increased amount of n-3 PUFAs, but retained the taste, structure, aroma, and mouthfeel of typical dry blended soup currently produced on the market.

### Example 18

### Profiling of Dry Blended Soup

Sensory descriptive analysis was conducted on dry blended soup to understand the attribute differences of soybean oil fat powder and SDA oil fat powder in dry blended soup. Eight panelists trained in the Sensory Spectrum™ Descriptive Profiling method evaluated the samples for 26 flavor attributes and 3 aftertaste attributes. The attributes were evaluated on a 15-point scale, with 0=none/not applicable and 15=very strong/high in each sample. Definitions of the flavor attributes are given in Table 21.

The samples were made by combining 460 g (2 cups) of water and 60 grams of dry blended soup powder in a saucepan and bringing the dry blended soup to a boil, stirring occasionally. The heat was reduced to low and the dry blended soup samples were simmered 10 to 15 minutes. Each panelist received 4 ounces of dry blended soup in 5 ounce bowls. The samples were presented monadically in triplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 21
Flavor Attribute Lexicon

| Attribute | Definition | Reference | |
|---|---|---|---|
| Aromatics | | Intensities based on | |
| | | Universal Scale: | |
| | | Baking Soda in | 2.5 |
| | | Saltine | |
| | | Cooked Apple in | 5.0 |
| | | Applesauce | |
| | | Orange in | 7.5 |
| | | Orange Juice | |
| | | Concord Grape in | 10.0 |
| | | Grape Juice | |
| | | Cinnamon in | 12.0 |
| | | Big Red Gum | |
| Overall Flavor | The overall intensity of the product aromas, | | |
| Impact | an amalgamation of all perceived aromatics. | | |
| Vegetable Complex | | | |
| Carrot | The aromatics associated with cooked carrots | canned carrots | |
| Celery | The aromatics associated with cooked celery | Cooked Celery | |
| Broccoli | The aromatic associated with raw, cooked, | Cooked broccoli | |
| | and dehydrated broccoli. | | |
| Potato | The aromatics associated with raw, cooked, | Cooked potato, Water left | |
| | and dehydrated potatoes and includes the | over from peeled boiled | |
| | starch from the potatoes. | potatoes | |
| Other Vegetable | | | |
| Green Herbs | The aromatics associated with fresh or | Oregano, thyme, basil, bay, | |
| | dried herbs | sage, parsley, etc. | |
| Cheese | The aromatics associated with hard cheeses | Parmesan, cheddar | |
| | (parmesan, Romano, etc. | | |
| Chicken | The general category used to describe the | Chicken bouillon cube | |
| | total chicken impact. | | |
| Onion/Garlic | The aromatics associated with dehydrated | Onion, garlic powder | |
| | onion, garlic powders | solutions. Garlic Oil | |
| | | Capsules | |
| White/black pepper | The aromatic associated with white and | White pepper and black | |
| | black pepper | pepper solutions | |
| Dairy | The aromatics associated with milk derived | 2% Milk | |
| | products - includes protein and fat | | |
| | aromatics. | | |
| Metallic | The aromatic associated with metals, tin | Iron tablet, canned tomato | |
| | or iron. | juice, pennies | |
| Grain | The aromatics associated with total grain | All-purpose flour paste, | |
| | impact, which may include all types of | cream of wheat, whole wheat | |
| | grain at different stages of heating. May | pasta, rice noodles | |
| | include wheat, whole wheat, oat, rice, | | |
| | graham, etc. | | |
| Cardboard/Woody | The aromatics associated with dried wood | Toothpicks, Water from | |
| | and the aromatics associated with slightly | cardboard soaked for 1 hour | |
| | oxidized fats and oils, reminiscent of a | | |
| | cardboard box. | | |
| Fishy/Pondy | The aroma/aromatics associated with | | |
| Complex | trimethylamine, pond water or aged fish. | | |
| | The general term used to describe fish | | |
| | meat, which cannot be tied to a specific | | |
| | fish by name. | | |
| Fishy | Aromatic associated with trimethylamine | Cod liver oil capsules, Geisha | |
| | and old fish. | canned lump crab, tuna in | |
| | | pouch | |
| Pondy | The aromas and aromatics associated with | Algal oil (Martek 30% DHA | |
| | water containing algae, reminiscent of | oil) | |
| | pond water and aquatic tanks. | | |
| BASIC TASTES | | | |
| Sweet | The taste on the tongue stimulated by | Sucrose solution: | |
| | sucrose and other sugars, such as | 2% | 2.0 |
| | fructose, glucose, etc., and by other | 5% | 5.0 |
| | sweet substances, such as saccharin, | 10% | 10.0 |
| | Aspartame, and Acesulfam-K. | 16% | 15.0 |
| Sour | The taste on the tongue stimulated by | Citric acid solution: | |
| | acid, such as citric, malic, phosphoric, | 0.05% | 2.0 |
| | etc. | 0.08% | 5.0 |
| | | 0.15% | 10.0 |
| | | 0.20% | 15.0 |
| Salt | The taste on the tongue associated with | Sodium chloride solution: | |
| | sodium salts. | 0.2% | 2.0 |
| | | 0.35% | 5.0 |
| | | 0.5% | 8.5 |
| | | 0.57% | 10.0 |
| | | 0.7% | 16.0 |
| Bitter | The taste on the tongue associated with | Caffeine solution: | |
| | caffeine and other bitter substances, such | 0.05% | 2.0 |
| | as quinine and hop bitters. | 0.08% | 5.0 |
| | | 0.15% | 10.0 |
| | | 0.20% | 15.0 |
| Umami | The taste on the tongue associated with | MSG solution | |
| | monosodium glutamate. Savory. | 6% | 5.0: |
| CHEMICAL FEELING | | | |
| FACTOR | | | |
| Astringent | The shrinking or puckering of the tongue | Alum solution: | |
| | surface caused by substances such as | 0.05% | 3.0 |
| | tannins or alum. | 0.10% | 6.0 |
| | | 0.2% | 9.0 |

| | | |
|---|---|---|
| Burn | A chemical feeling factor associated | Lemon juice, vinegar |
| | with high concentration of irritants to the | |
| | mucous membranes of the oral cavity. | |

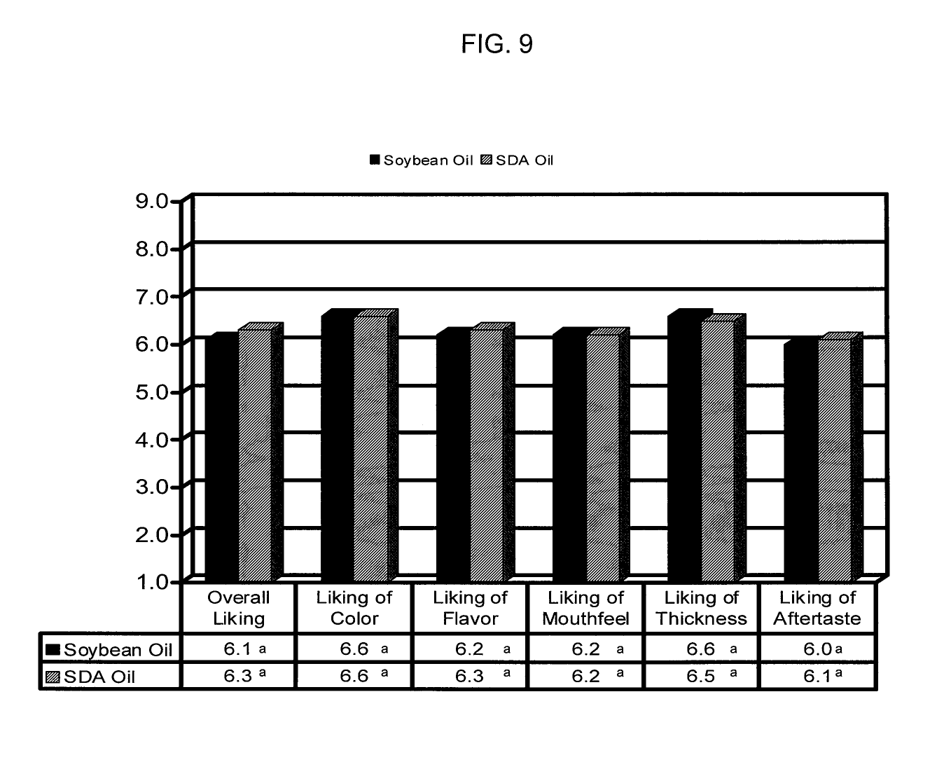

There were detectable differences between the soybean oil fat powder and SDA oil fat powder, shown in Table 22. The soybean oil fat powder and SDA oil fat powder had similar profiles, except the SDA oil fat powder dry blended soup sample was significantly higher in White/Black Pepper aromatics (FIG. 9). Fishy/Pondy aromatics in the SDA oil fat powder sample were below the recognition threshold (2.0), therefore consumers would not be able to detect these aromatics in the sample.

TABLE 22
Flavor and Aftertaste Attributes for Dry Blended Soup

| | Soybean Oil | SDA Oil | HSD | |
|---|---|---|---|---|
| Aromatics | Fat Powder | Fat Powder | value | p value |
| Overall Flavor Impact | 7.0 a | 7.1 a | 0.204 | NS |
| Vegetable Complex | 4.8 a | 4.8 a | 0.268 | NS |
| Carrot | 2.2 a | 2.3 a | 0.347 | NS |
| Celery | 2.2 a | 2.2 a | 0.116 | NS |
| Broccoli | 1.3 a | 1.5 a | 0.560 | NS |
| Potato | 3.0 a | 2.9 a | 0.209 | NS |
| Other Vegetable | 0.1 a | 0.0 a | 0.173 | NS |
| Green Herbs | 2.2 a | 2.1 a | 0.268 | NS |
| Cheese | 2.3 a | 2.2 a | 0.119 | NS |
| Chicken | 2.4 a | 2.4 a | 0.169 | NS |
| Onion/Garlic | 2.1 a | 2.2 a | 0.152 | NS |
| White/Black Pepper | 2.1 b | 2.3 a | 0.098 | *** |
| Dairy | 1.7 a | 1.8 a | 0.455 | NS |
| Metallic | 0.3 a | 0.3 a | n/a | NS |
| Grain | 0.8 a | 0.8 a | n/a | NS |
| Cardboard/Woody | 2.0 a | 2.0 a | 0.043 | NS |
| Fishy/Pondy Complex | 0.0 a | 0.2 a | 0.239 | NS |
| Fishy | 0.0 a | 0.2 a | 0.239 | NS |
| Pondy | 0.0 | 0.0 | n/a | n/a |
| Basic Tastes & | | | | |
| Feeling Factors | | | | |
| Sweet | 1.7 a | 1.8 a | 0.071 | * |
| Sour | 2.0 a | 2.0 a | 0.095 | NS |
| Salt | 5.2 a | 5.4 a | 0.317 | NS |
| Bitter | 2.0 a | 2.0 a | 0.116 | NS |
| Umami | 2.2 a | 2.3 a | 0.123 | NS |
| Astringent | 2.4 a | 2.4 a | 0.062 | NS |
| Burn | 0.0 | 0.0 | n/a | n/a |
| Aftertaste | | | | |
| Overall Aftertaste | 2.8 a | 2.7 a | 0.106 | NS |
| Impact | | | | |
| Fishy Aftertaste | 0.0 | 0.0 | n/a | n/a |
| Pondy Aftertaste | 0.0 | 0.0 | n/a | n/a |

Means in the same row followed by the same letter are not significantly different at 95% Confidence.
*** 99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 19

### Acceptance of Dry Blended Soup

To evaluate sensory parity of soybean oil fat powder and SDA oil fat powder consumer acceptability based on soybean oil fat powder and SDA oil fat powder was analyzed for dry blended soup. The acceptance ratings were compared between the soybean oil fat powder and SDA oil fat powder dry blended soup.

The samples were evaluated by 55 consumers willing to try dry blended vegetable soup. The judges used a 9-point Hedonic acceptance scale. The Hedonic scale ranged from 1 being dislike extremely to 9 being like extremely and was used for Overall Liking, Color Liking, Flavor Liking, Mouthfeel Liking, Thickness Liking, and Aftertaste Liking.

Consumers evaluated 4 ounces of dry blended soup served in 5 ounce bowls. The dry blended soup was prepared by combining 2 cups of water and 60 grams of powder in a saucepan bringing the dry blended soup to a boil, stirring occasionally. Then reducing the heat to low and simmering the dry blended soup 10 to 15 minutes. The samples were served by sequential monadic presentation (one at a time).

The data were analyzed using the Analysis of Variance (ANOVA) to account for panelist and sample effects, with mean separations using Tukey's Significant Difference (HSD) Test.

There were no significant differences between the soybean oil fat powder and SDA oil fat powder dry blended soup in Overall Liking, Color Liking, Flavor Liking, Mouthfeel Liking, Thickness Liking, and Aftertaste Liking (FIG. 10).

While the invention has been explained in relation to exemplary embodiments, it is to be understood that various modifications thereof will become apparent to those skilled in the art upon reading the description. Therefore it is to be understood that the invention disclosed herein is intended to cover such modification as fall within the scope of the appended claims.

1. A soup composition having an amount of omega-3 fatty acids, wherein the soup composition comprises
a. a quantity of a stearidonic acid; and
b. at least one stabilizing agent.

2. The soup composition of claim 1, wherein the at least one stabilizing agent is at least one antioxidant.

3. The soup composition of claim 1, wherein the soup is selected from the group consisting of ready to serve soups, ready-to-eat soups, canned condensed soups, dry mix soups, clear soups, thick soups, broths, cream soups, bisques, chowders, purees, meat based soups, vegetable based soups, meat and vegetable soups, soups with particulates, cold or chilled soups, dessert soups, fish soups, beverage soups, fermented soups, and combinations thereof.

4. The soup composition of claim 1, wherein the composition includes a protein selected from the group consisting of soy protein, pea protein, milk protein, rice protein, collagen, and combinations thereof.

5. The soup composition of claim 1, wherein the stearidonic acid is selected from the group consisting of stearidonic enriched soybean oil, stearidonic acid enriched soy flour, and combinations thereof.

6. The soup composition of claim 2, wherein the antioxidant is selected from the group consisting of synthetic antioxidants, natural antioxidants, phospholipids, and combinations thereof.

7. The soup composition of claim 1, wherein the at least one stabilizing agent ranges between about 0.01% to about 65% by weight of the stearidonic acid.

8. The soup composition of claim 1, wherein the sensory characteristics of the soup composition are comparable to the sensory characteristics of soup compositions that do not contain stearidonic acid.

9. A method of using stearidonic acid to form a soup, wherein the method comprises adding
a. a quantity of stearidonic acid; and
b. at least on stabilizing agent to the soup.

10. The method of claim 9 wherein the stearidonic acid comprises between about 1% and about 100% of fat required in the soup.

11. The method of claim 9, wherein the at least one stabilizing agent is at least one antioxidant.

12. A sauce composition having an amount of omega-3 fatty acids, wherein the composition comprises
a. a quantity of stearidonic acid; and
b. at least one stabilizing agent.

13. The sauce composition of claim 12, wherein the at least one stabilizing agent is at least one antioxidant.

14. The sauce composition of claim 12, wherein the sauce composition is selected from the group consisting of ready made sauces, salad sauces, pan sauces, vegetable sauces, dessert sauces, chocolate sauces, caramel sauces, white sauces, brown sauces, emulsified sauces, sweet sauces, fruit sauces, cooked sauces, jellies, jams, preserves, chutneys, compotes, applesauce, salsas, puddings, gelatins, mole sauces, sauce bases, cooked sauces, gravies, and combinations thereof.

15. The sauce composition of claim 12, wherein the sensory characteristics of the sauce composition are comparable to the sensory characteristics of sauce compositions that do not contain stearidonic acid.

16. A fat powder composition having an amount of omega-3 fatty acids, wherein the composition comprises
a. a quantity of a stearidonic acid; and
b. at least one stabilizing agent.

17. The fat powder composition of claim 16, wherein the at least one stabilizing agent is at least one antioxidant.

18. The fat powder composition of claim 16, wherein the at least one antioxidant is selected from the group consisting of synthetic antioxidants, natural antioxidants, phospholipids, and combinations thereof.

19. The fat powder composition of claim 16, wherein the fat powder is selected from the group consisting of dry blended beverages, dry blended beverages for weight loss, dry blended beverages for weight gain, dry blended beverages for sports nutritional purposes, infant formulas, clinical nutrition products, dry blended soups, and combinations thereof.

20. The fat powder composition of claim 16, wherein the sensory characteristics of the fat powder composition are comparable to the sensory characteristics of fat powder compositions that do not contain stearidonic acid.
